(19) United States
(12) Patent Application Publication
(10) Pub. No.: US 2015/0333312 A1
(43) Pub. Date: Nov. 19, 2015

(54) ASSEMBLED BATTERY

(71) Applicant: HITACHI AUTOMOTIVE SYSTEMS, LTD., Hitachinaka-shi, Ibaraki (JP)

(72) Inventors: Masayuki NAKAMOTO, Hitachinaka (JP); Sadayuki AOKI, Hitachinaka (JP)

(73) Assignee: HITACHI AUTOMOTIVE SYSTEMS, LTD., Hitachinaka-shi, Ibaraki (JP)

(21) Appl. No.: 14/655,790

(22) PCT Filed: Jan. 4, 2013
(86) PCT No.: PCT/JP2013/050007

§ 371 Date: Jun. 26, 2015

(51) Int. Cl. H01M 2/20; H01M 2/10

(52) U.S. Cl. CPC H01M 2/206; H01M 2/1077

(57) ABSTRACT

An assembled battery is configured by connecting a plurality of battery cells arranged in a laminated structure via a bus bar. The battery cell includes a first electrode terminal and a second electrode terminal; and the bus bar includes a first electrode connection portion connected to the first electrode terminal of one battery cell and a second electrode connection portion connected to the second electrode terminal of another battery cell adjacent to the one battery cell. A connecting device, configured with the bus bar, the first electrode terminal of the one battery cell and the second electrode terminal of the other battery cell, includes a space-forming portion that forms a space where relative displacement of the second electrode connection portion and the second electrode terminal, occurring when the other battery cell is disposed with an offset from a reference position thereof along a laminating direction in which the battery cells are laminated and/or a direction running perpendicular to the laminating direction relative to the one battery cell, is absorbed; and the second electrode terminal and the second electrode connection portion are butt-welded or lap-welded.

### TECHNICAL FIELD

The present invention relates to an assembled battery constituted with a plurality of battery cells electrically connected via a bus bar.

### BACKGROUND ART

There is an assembled battery known in the related art, which is achieved by connecting electrode terminals of a plurality of battery cells with one another via a bus bar (conductive member) (see PTL 1). Each electrode terminal in the assembled battery disclosed in PTL 1 is formed in a stepped shape having a first step part and a second step part, located above the first step part and having a diameter smaller than that of the first step part. The bus bar includes a terminal connector plate having formed therein an opening with a diameter smaller than the diameter of the first step part and substantially equal to the diameter of the second step part and a notch running along at least part of the circumferential edge of the opening. With the second step part of an electrode terminal fitted within the opening, the terminal connector plate is bonded onto the first step part.

In the assembled battery disclosed in PTL 1, the second step part of the electrode terminal is fitted into the opening at the terminal connector plate by applying pressure to the bus bar. During this process, the shape of the terminal connector plate becomes altered in correspondence to the shape of the second step part.

### CITATION LIST

### Patent Literature

PTL 1: Japanese Laid Open Patent Publication No. 2011-171192

### SUMMARY OF INVENTION

### Technical Problem

When pressing the second step part into the opening at the terminal connector plate in the assembled battery disclosed in PTL 1, the bus bar must be pressed with significant pressure and thus, the process of bus bar mounting is bound to be laborious.

### Solution to Problem

An assembled battery according to a first aspect of the present invention comprises: a plurality of battery cells arranged in a laminated structure and connected via a bus bar, wherein: the battery cells each include a first electrode terminal and a second electrode terminal; the bus bar includes a first electrode connection portion connected to the first electrode terminal of one battery cell and a second electrode connection portion connected to the second electrode terminal of another battery cell adjacent to the one battery cell; a connecting device is configured with the bus bar, the first electrode terminal of the one battery cell and the second electrode terminal of the other battery cell, wherein the connection device includes a space-forming portion that forms a space where relative displacement of the second electrode connection portion and the second electrode terminal, occurring when the other battery cell is disposed with an offset from a reference position thereof along a laminating direction in which the battery cells are laminated and/or a direction running perpendicular to the laminating direction relative to the one battery cell, is absorbed; and the second electrode terminal and the second electrode connection portion are butt-welded or lap-welded.

### Advantageous Effects of Invention

According to the present invention, the bus bar can be connected to the first electrode terminal and the second electrode terminal of battery cells by positioning the bus bar without applying pressure.

### BRIEF DESCRIPTION OF DRAWINGS

FIG. 1 A perspective, presenting an external view of an assembled battery achieved in a first embodiment

FIG. 2 A perspective showing the structure of the assembled battery achieved in the

### FIRST EMBODIMENT

FIG. 3 A perspective of a battery cell

FIG. 4 An illustration of a negative terminal in a first battery cell, a positive terminal in a second battery cell and a bus bar in a perspective

FIG. 5 A schematic side elevation, presenting a view taken from one side along the Y direction in FIG. 4

FIG. 6 (a) Presenting a schematic plan view of an electrode connecting device configured with the bus bar, the negative terminal and the positive terminal in FIG. 4 and (b) presenting a schematic enlargement of area A in (a)

FIG. 7 A schematic plan view of the butt-weld area where the bus bar and the positive terminal are butt-welded and the butt-weld area where the bus bar and the negative terminal are butt-welded

FIG. 8 A schematic plan view of the first battery cell and the second battery cell offset relative to the first battery cell along the laminating direction

FIG. 9 A schematic plan view of the first battery cell and the second battery cell offset relative to the first battery cell along the widthwise direction

FIG. 10 A perspective of an electrode connecting device for an assembled battery, achieved as a variation of the first embodiment

FIG. 11 A schematic plan view of an electrode connecting device for an assembled battery, achieved in a second embodiment

FIG. 12 A schematic plan view of the first battery cell and the second battery cell offset relative to the first battery cell along the laminating direction

FIG. 13 A schematic plan view of the first battery cell and the second battery cell offset relative to the first battery cell along the widthwise direction

FIG. 14 A perspective of an electrode connecting device for an assembled battery, achieved as a variation of the second embodiment

FIG. 15 A schematic plan view of an electrode connecting device for an assembled battery, achieved in a third embodiment

FIG. 16 A schematic plan view of the first battery cell and the second battery cell offset relative to the first battery cell along the laminating direction

FIG. 17 A schematic plan view of the first battery cell and the second battery cell offset relative to the first battery cell along the widthwise direction

FIG. 18 A perspective of an electrode connecting device for an assembled battery, achieved as a variation of the third embodiment

FIG. 19 A schematic plan view of an electrode connecting device for an assembled battery, achieved in a fourth embodiment

FIG. 20 A schematic plan view of the first battery cell and the second battery cell offset relative to the first battery cell along the widthwise direction

FIG. 21 A perspective view of an electrode connecting device for an assembled battery, achieved in a fifth embodiment

FIG. 22 A schematic side elevation presenting a view taken from direction E in FIG. 21

FIG. 23 A schematic plan view of the electrode connecting device in FIG. 21

FIG. 24 A schematic plan view of the first battery cell and the second battery cell offset relative to the first battery cell along the laminating direction

FIG. 25 A schematic plan view of the first battery cell and the second battery cell offset relative to the first battery cell along the widthwise direction

FIG. 26 A perspective view of an electrode connecting device for an assembled battery, achieved in a sixth embodiment

FIG. 27 A schematic plan view of the electrode connecting device in FIG. 26

FIG. 28 A schematic plan view of the first battery cell and the second battery cell offset relative to the first battery cell along the laminating direction

FIG. 29 A schematic plan view of the first battery cell and the second battery cell offset relative to the first battery cell along the widthwise direction

FIG. 30 A schematic plan view of an electrode connecting device for an assembled battery, achieved as a variation of the fifth embodiment

FIG. 31 A schematic plan view of an electrode connecting device for an assembled battery, achieved as a variation of the sixth embodiment

### DESCRIPTION OF EMBODIMENTS

The following is a description of embodiments achieved by adopting the present invention in an assembled battery that includes a plurality of flat prismatic lithium-ion secondary batteries (hereafter referred to as battery cells), given in reference to the drawings.

### First Embodiment

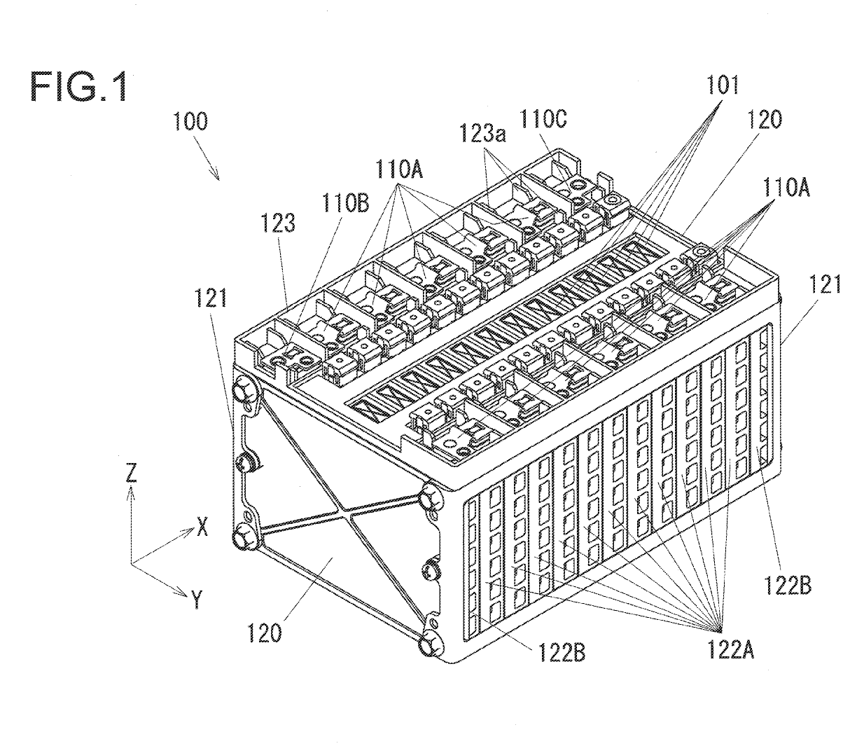

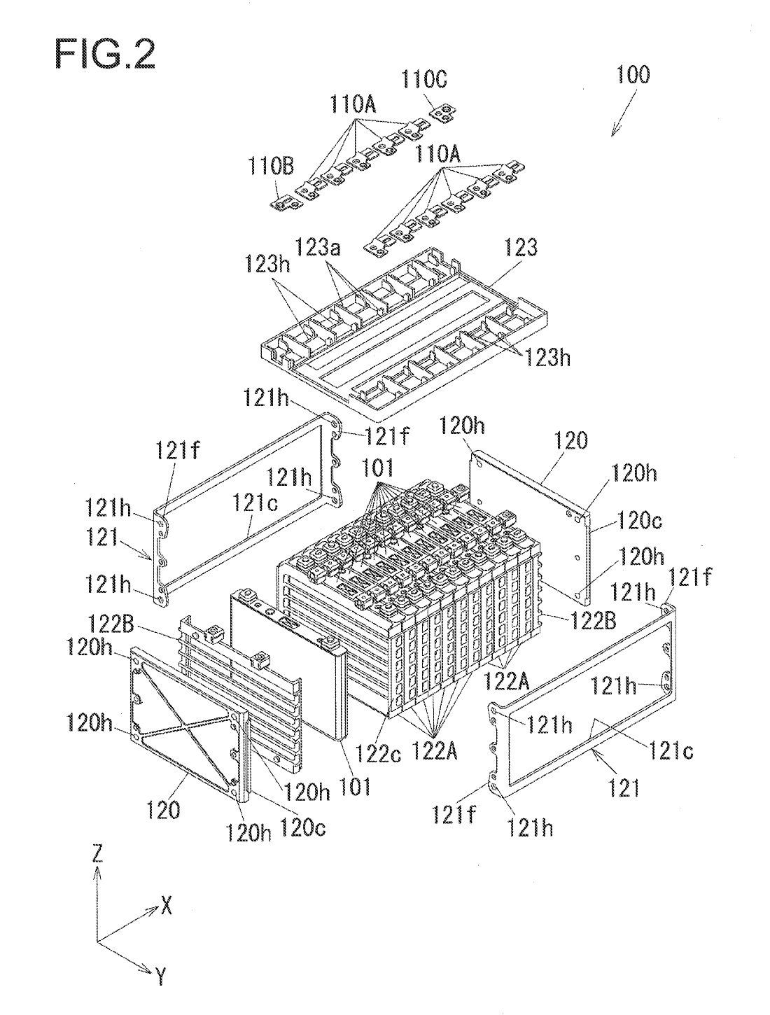

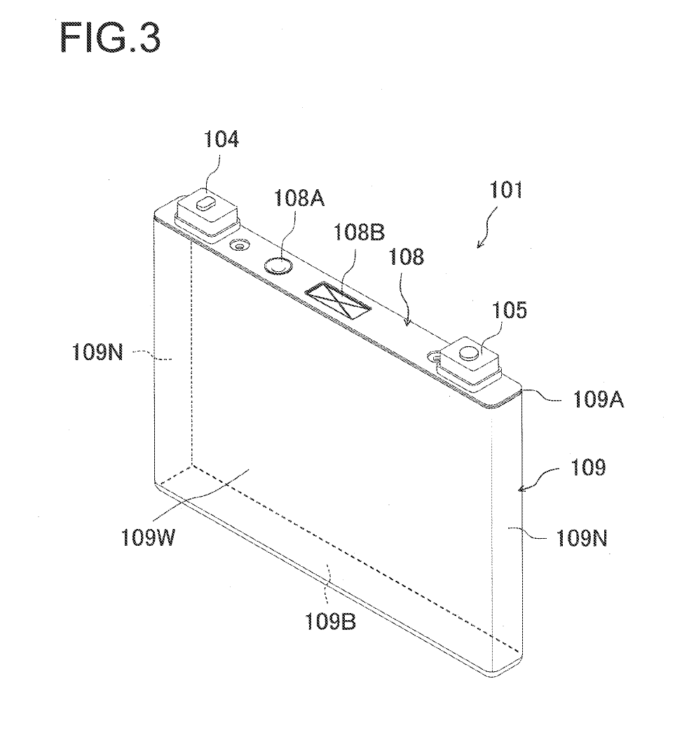

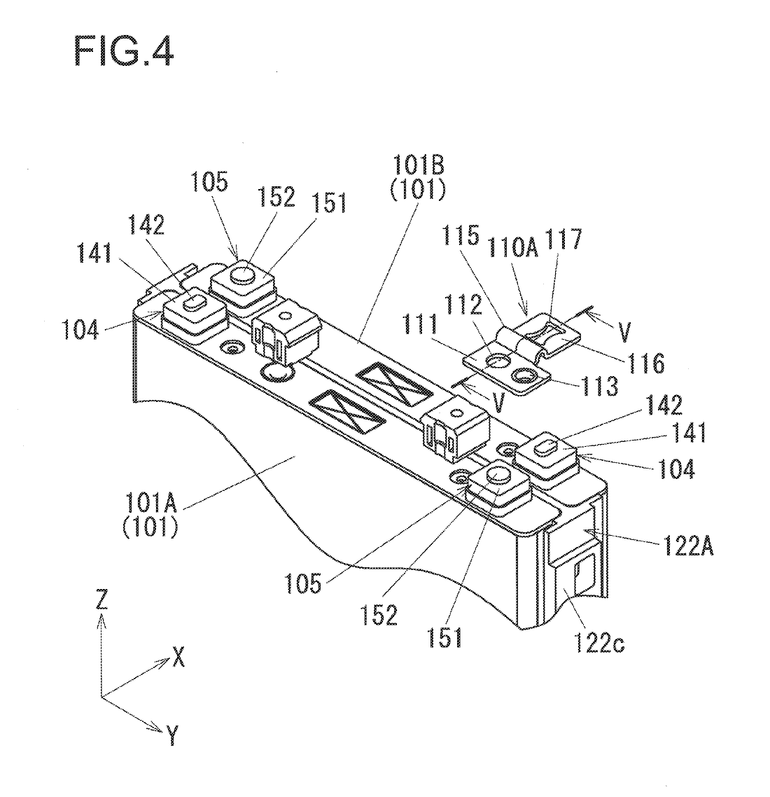

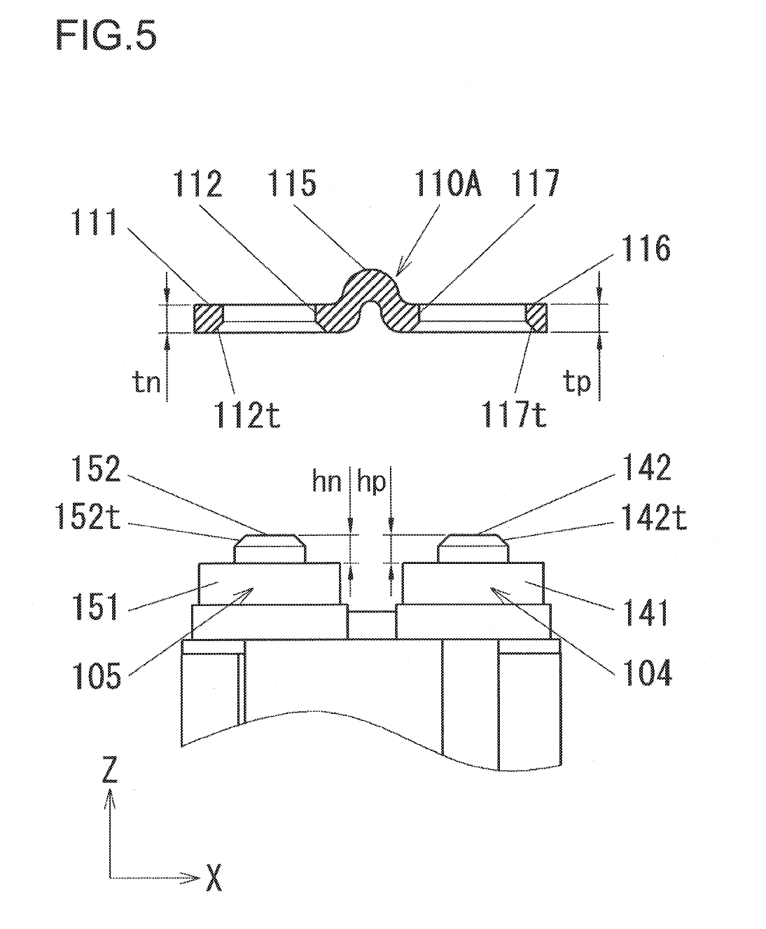

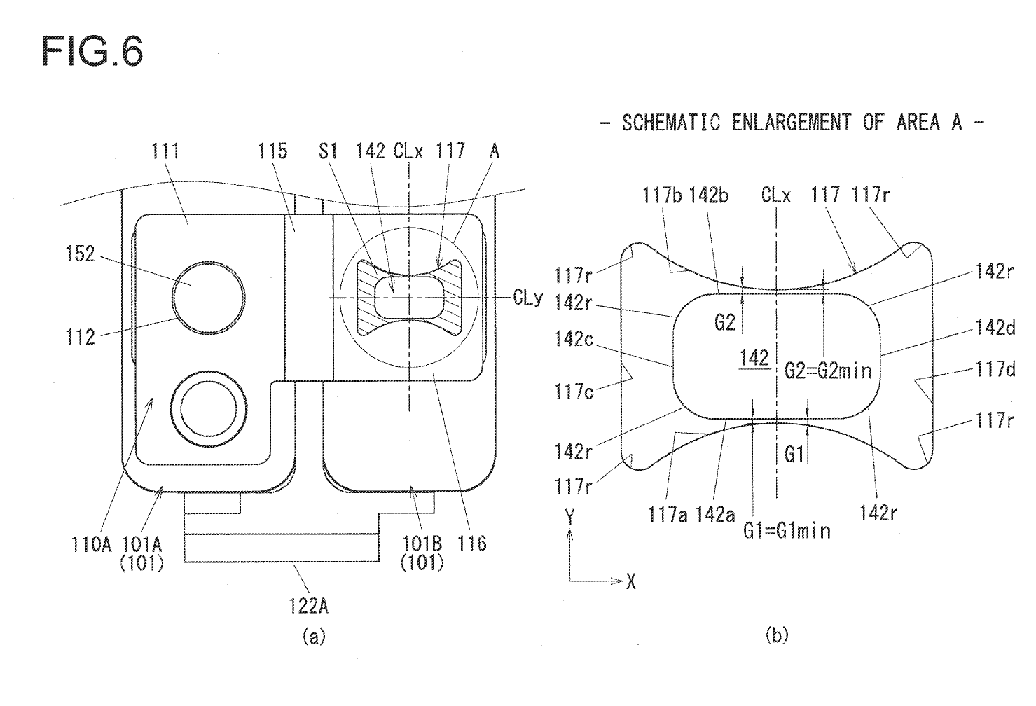

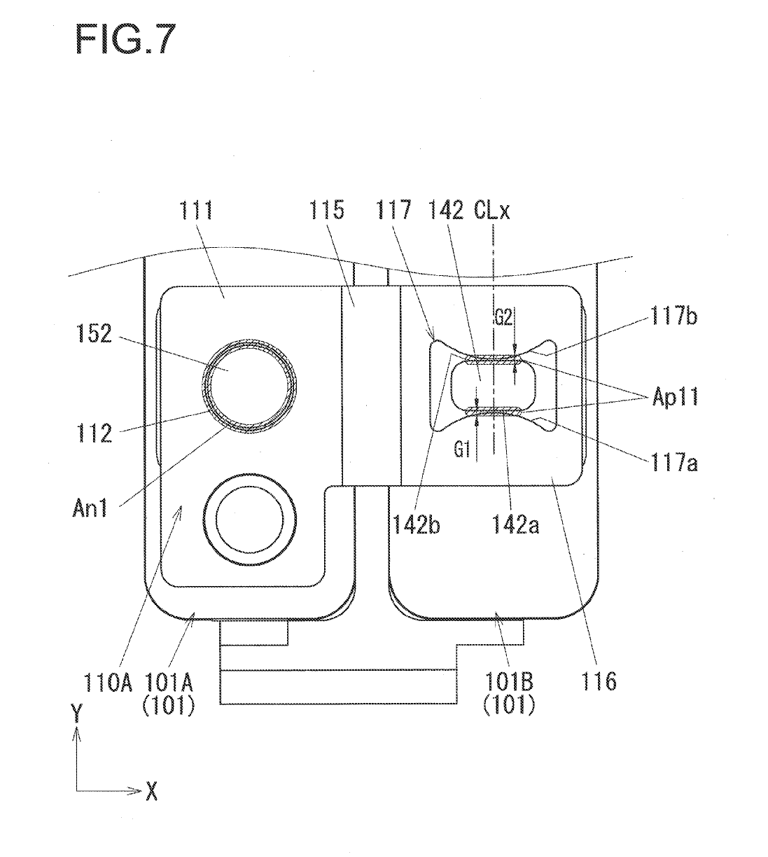

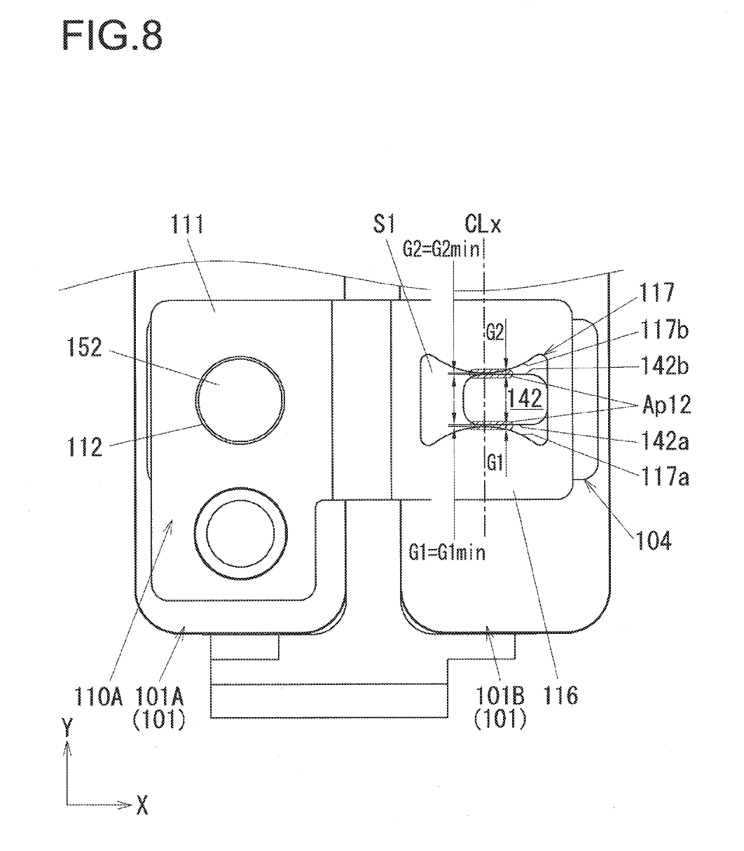

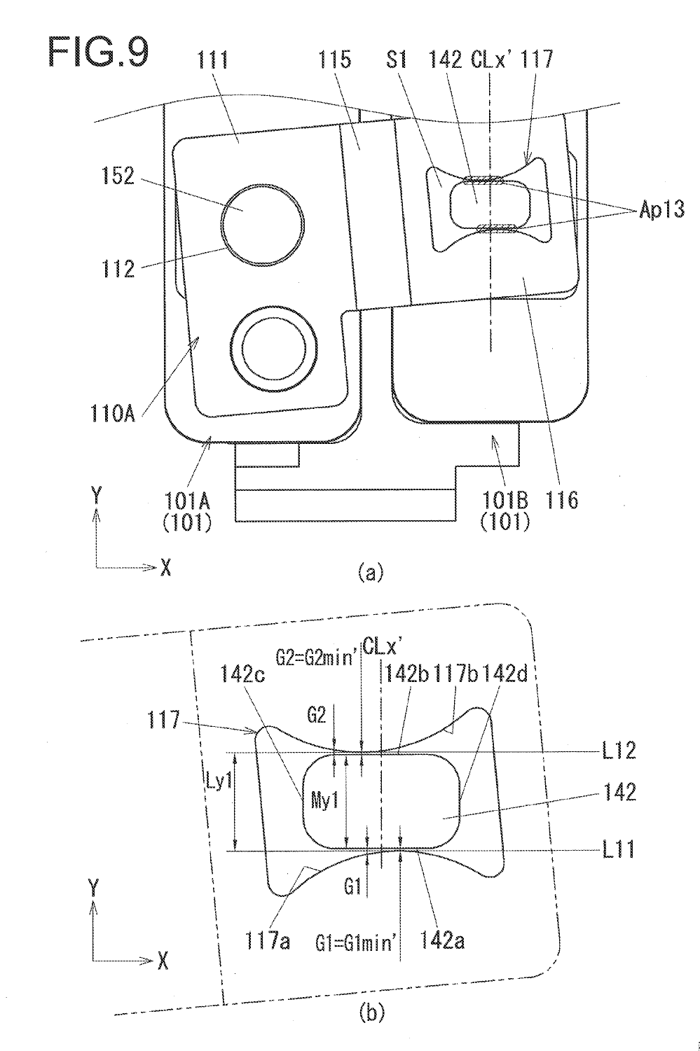

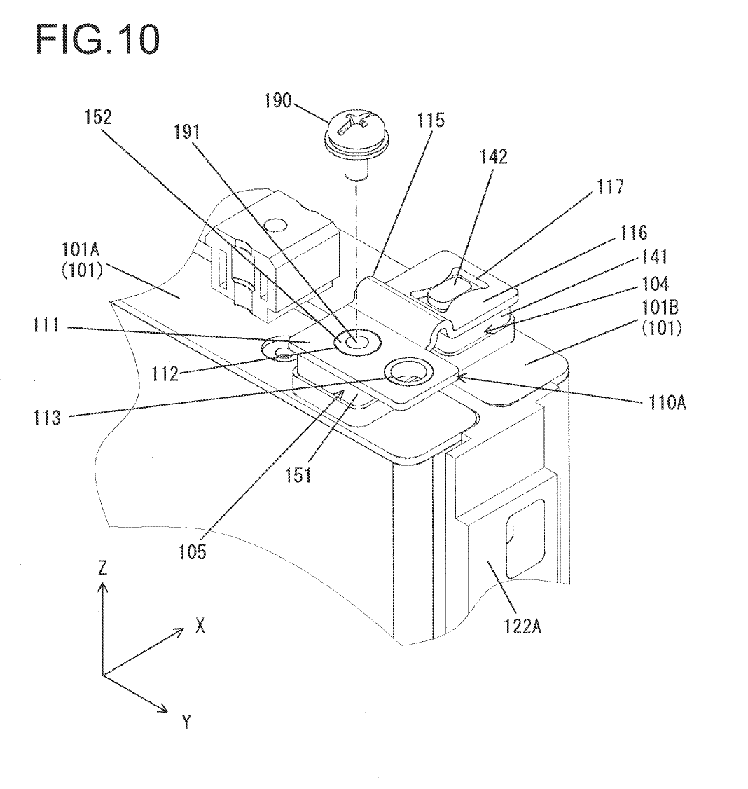

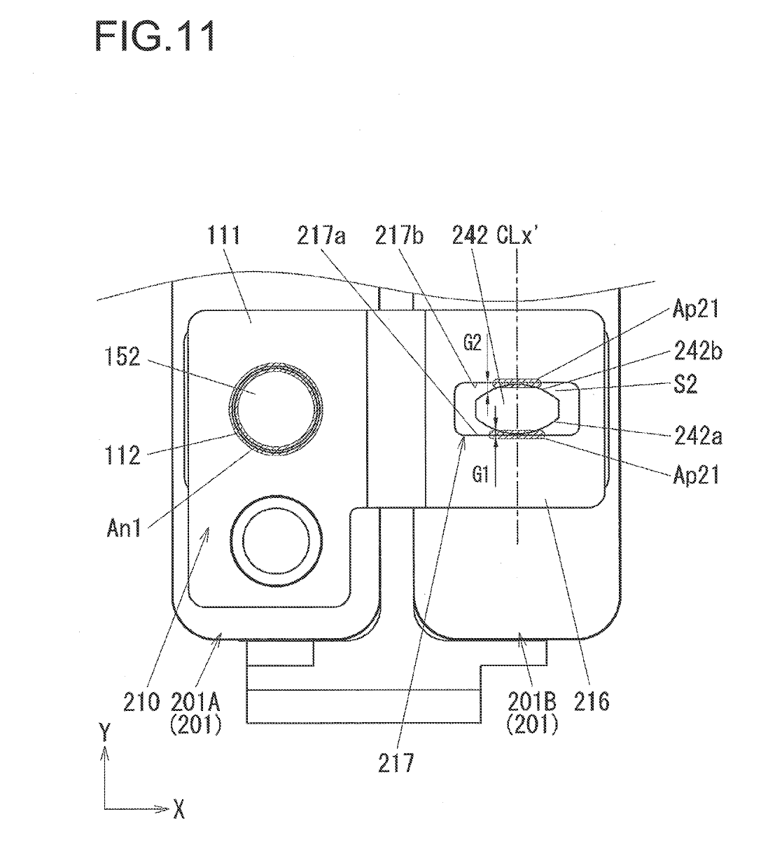

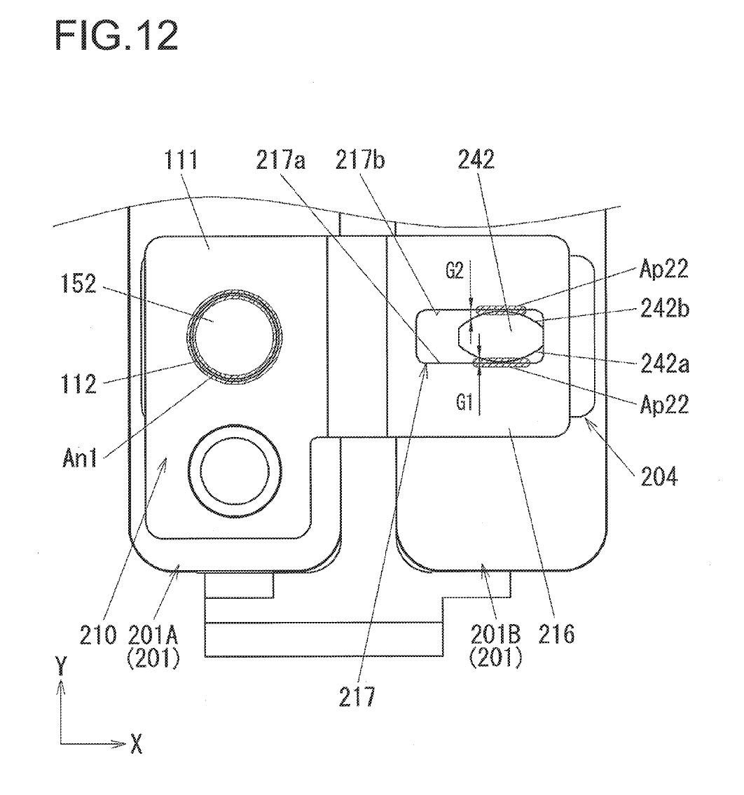

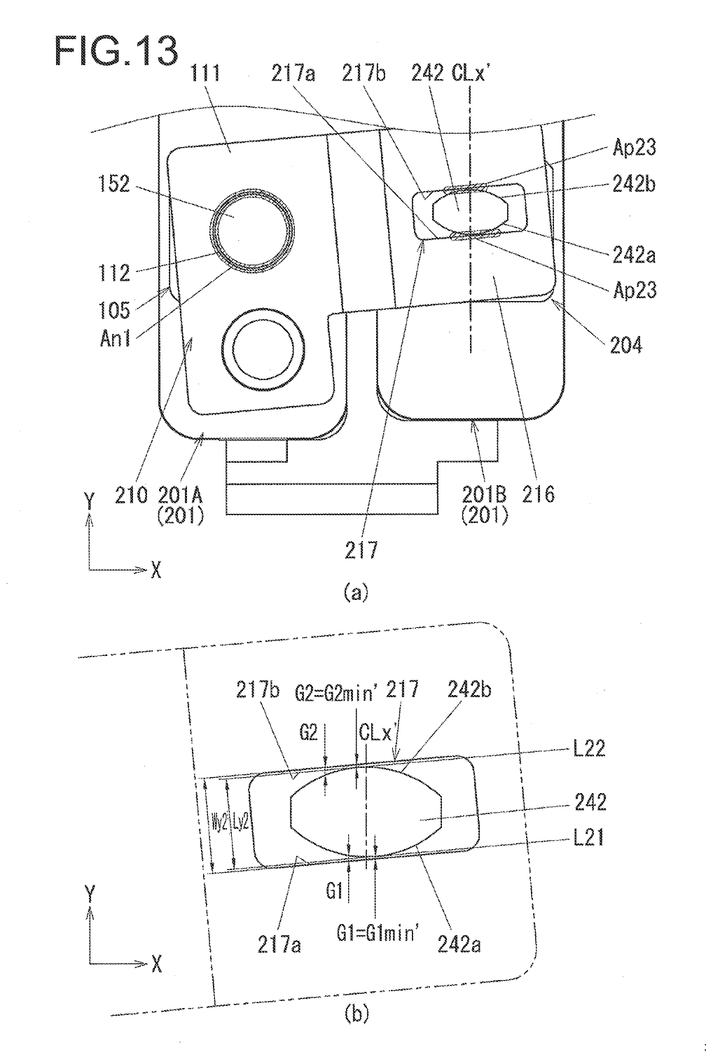

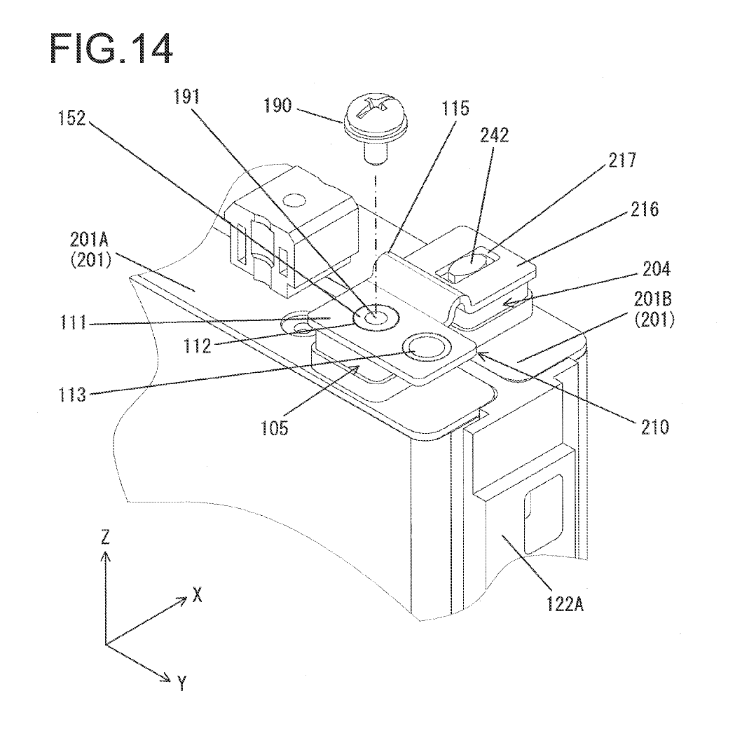

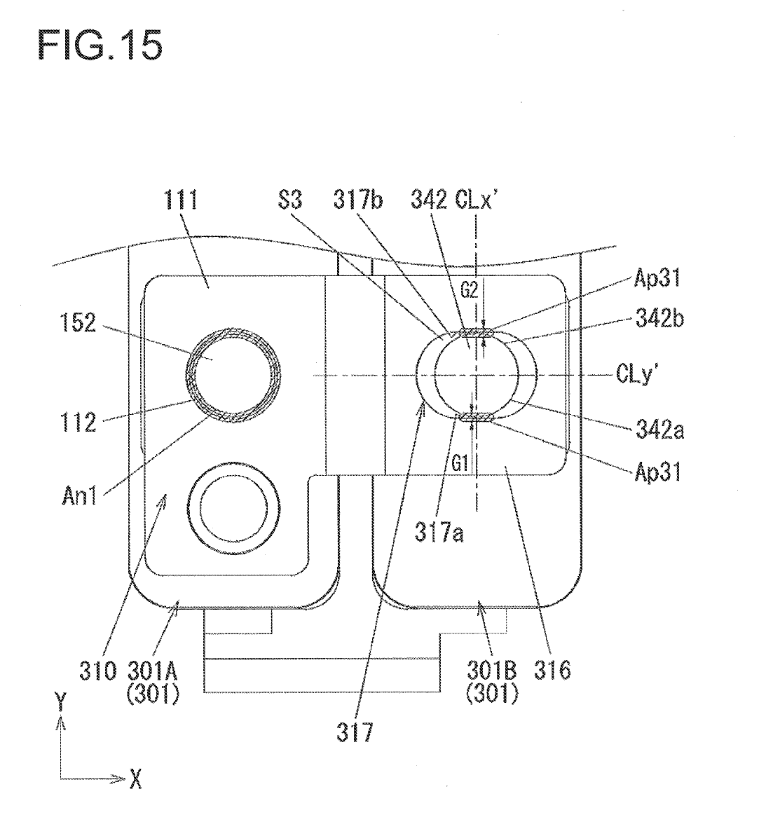

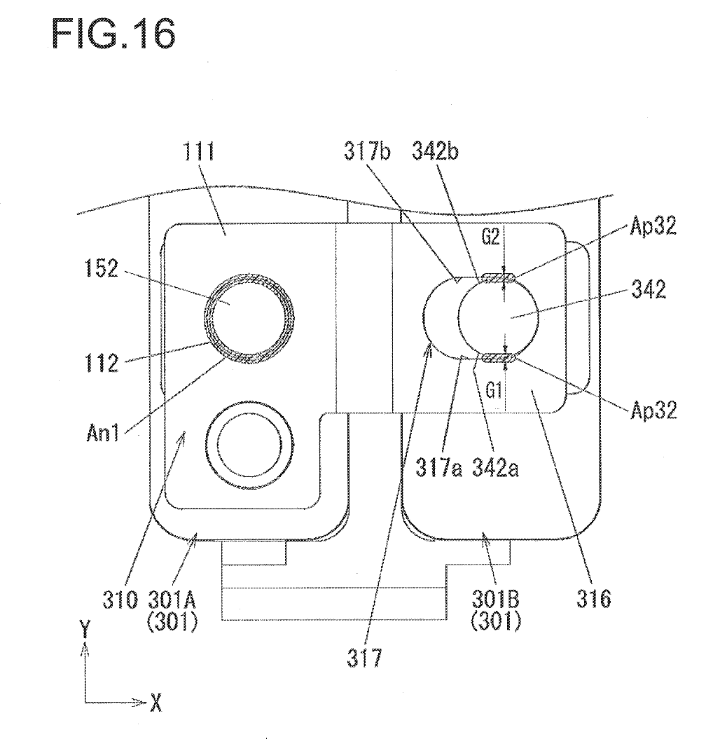

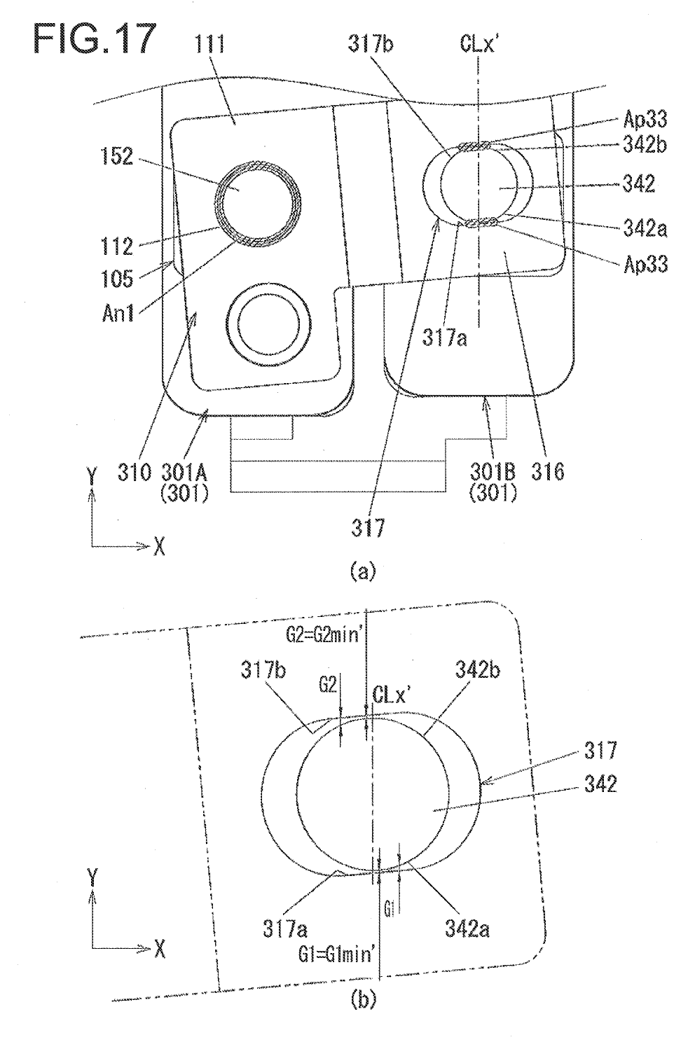

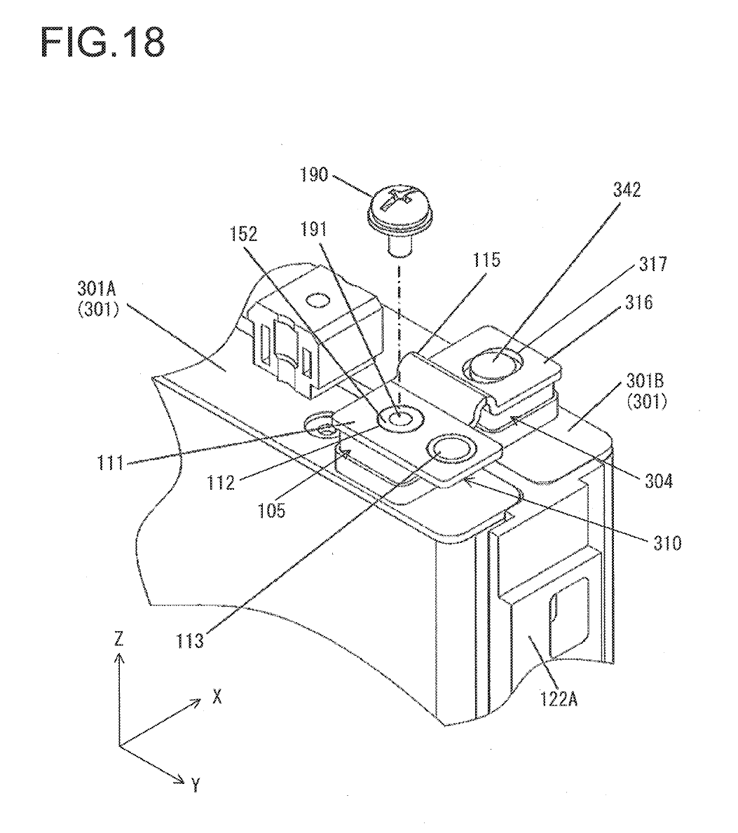

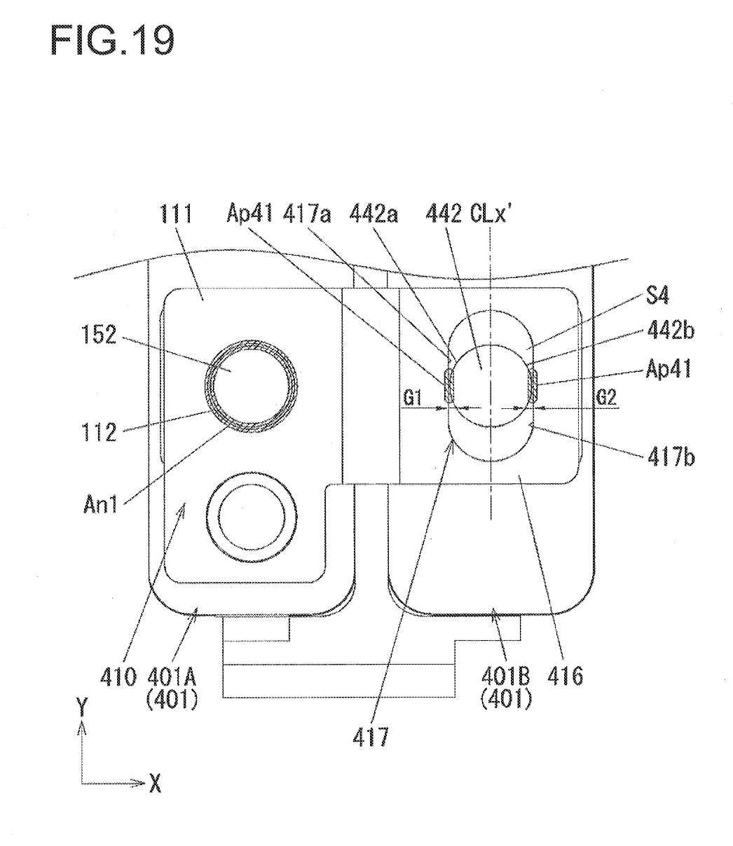

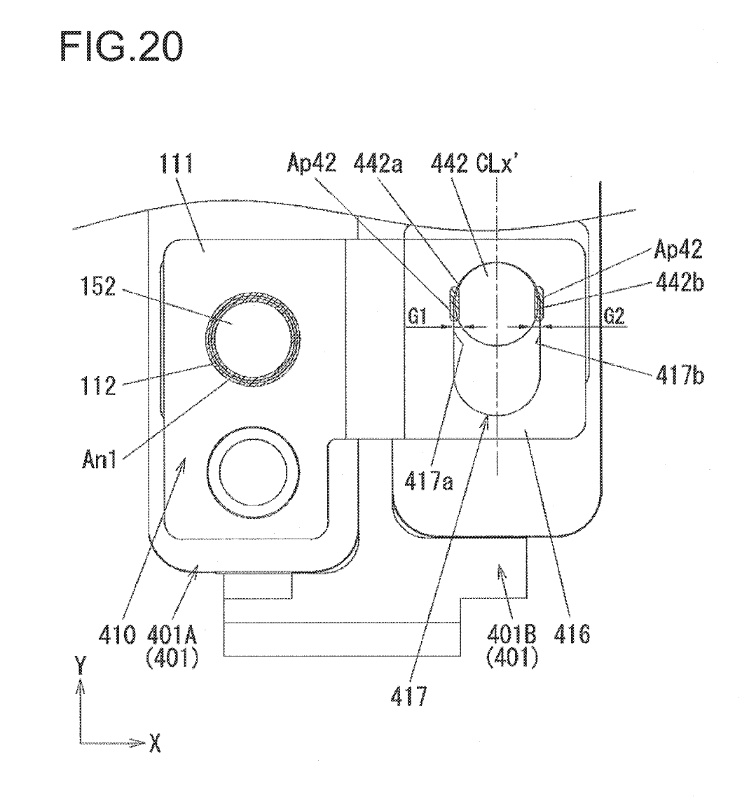

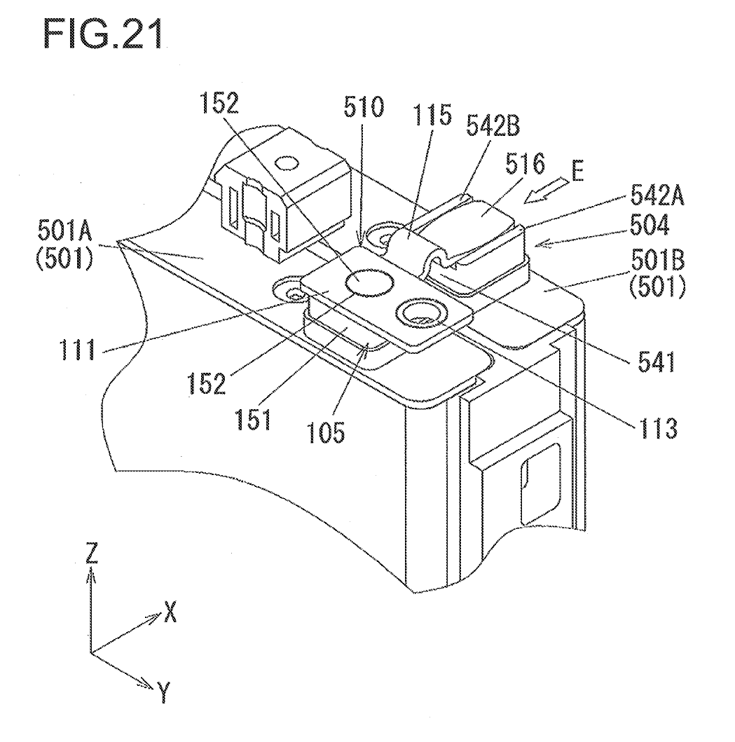

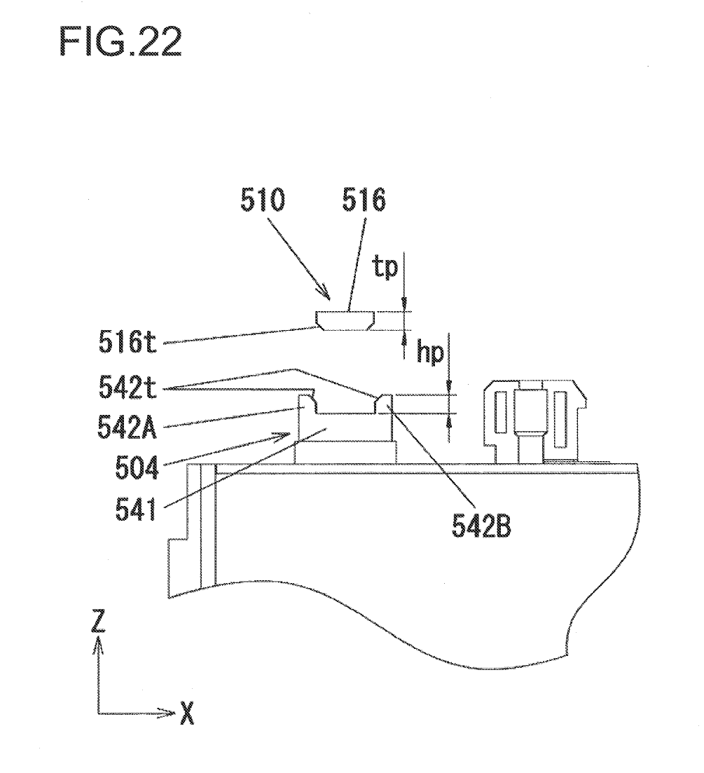

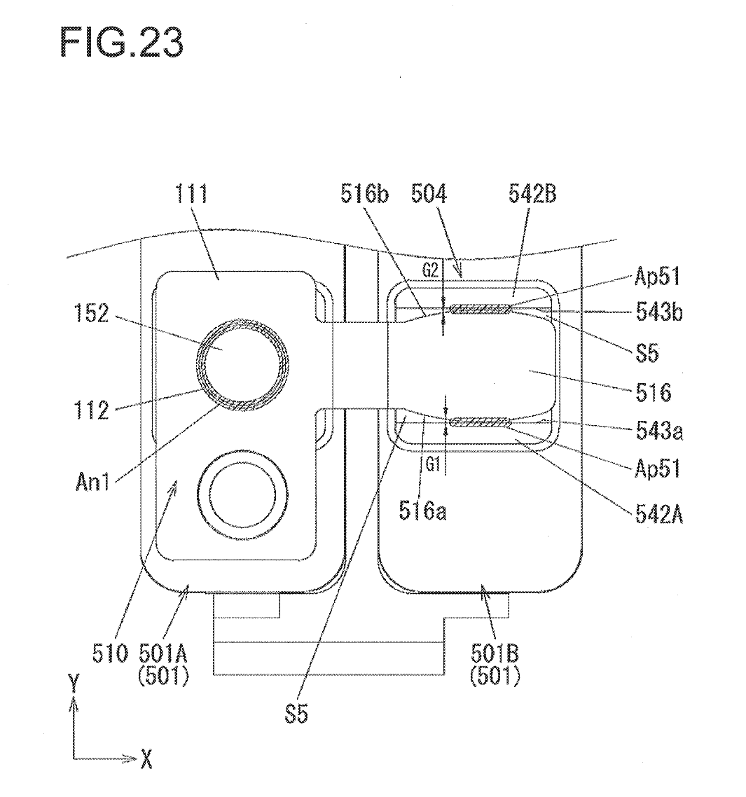

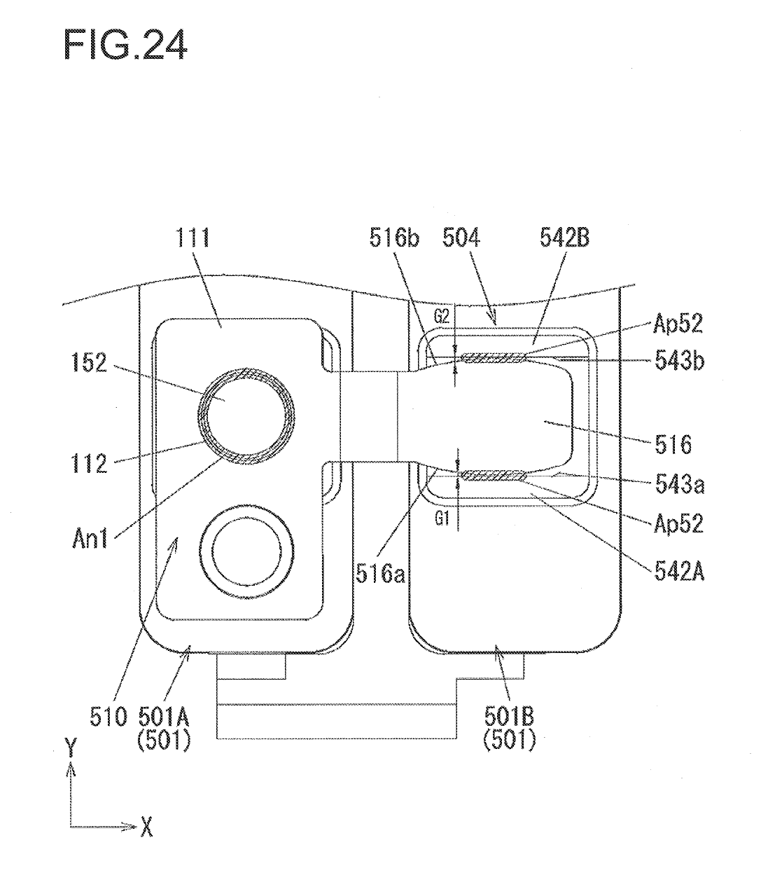

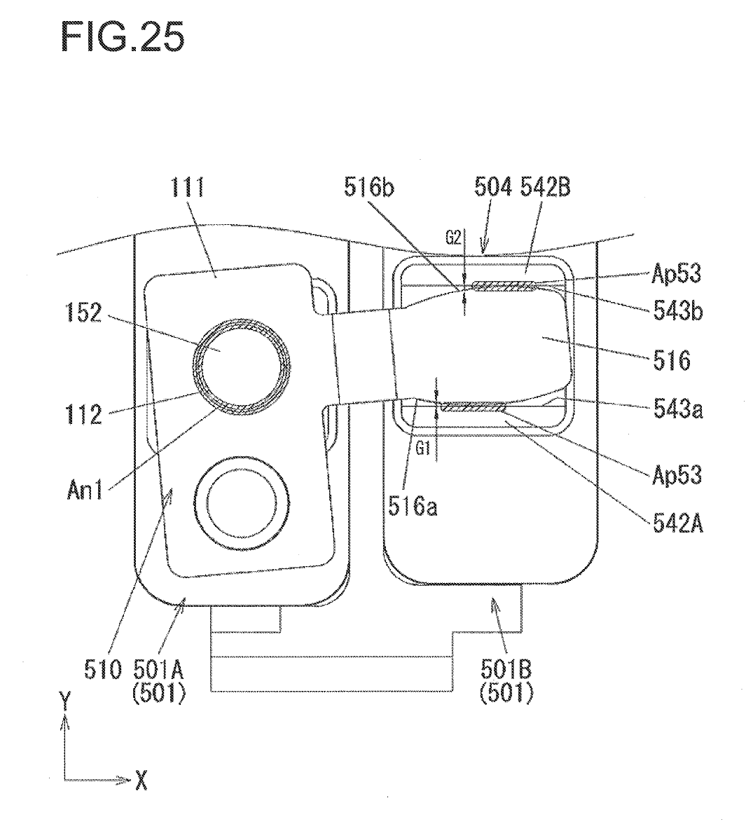

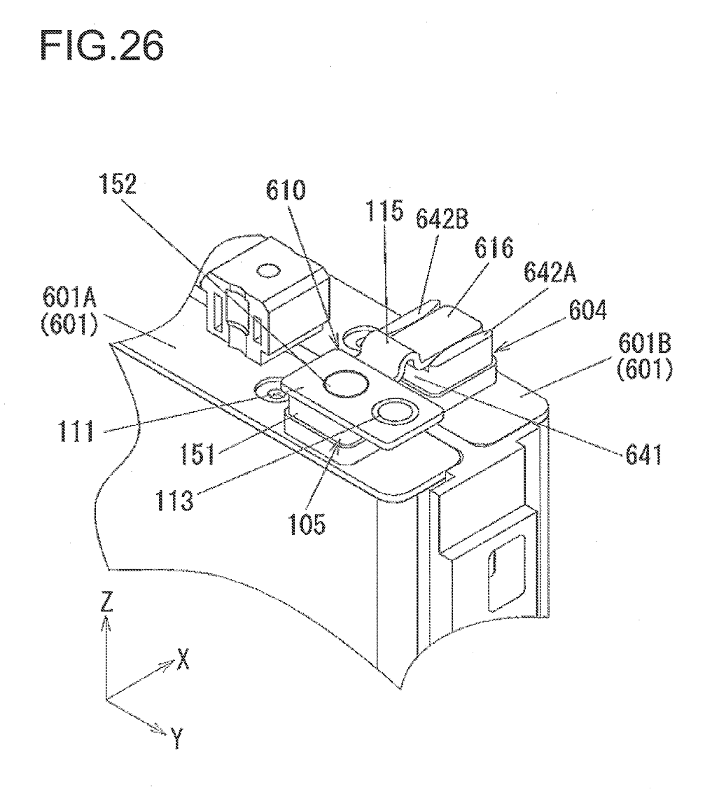

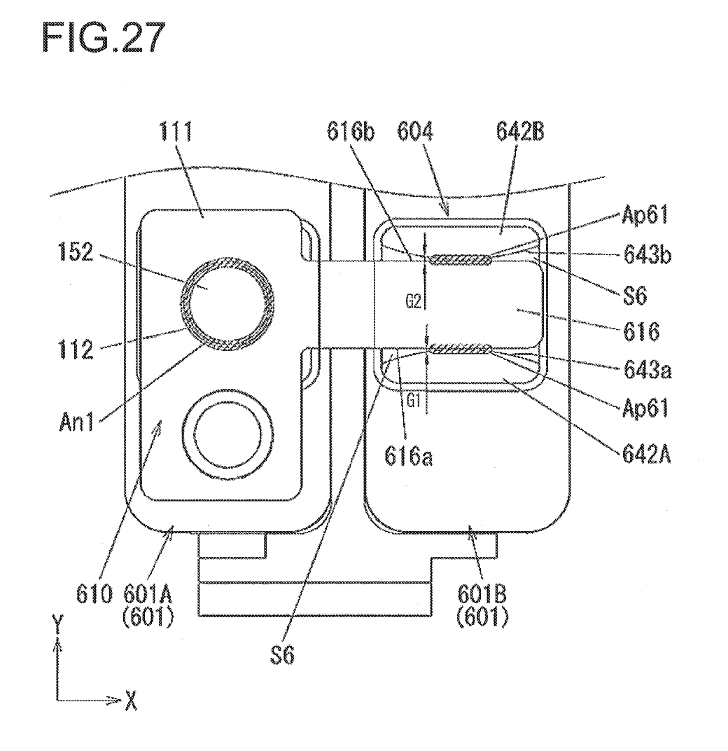

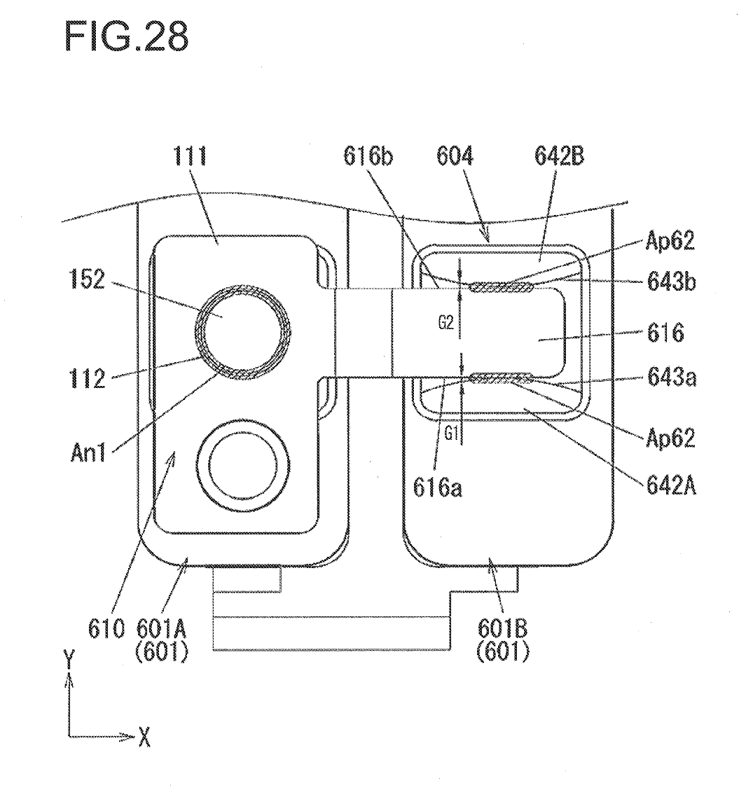

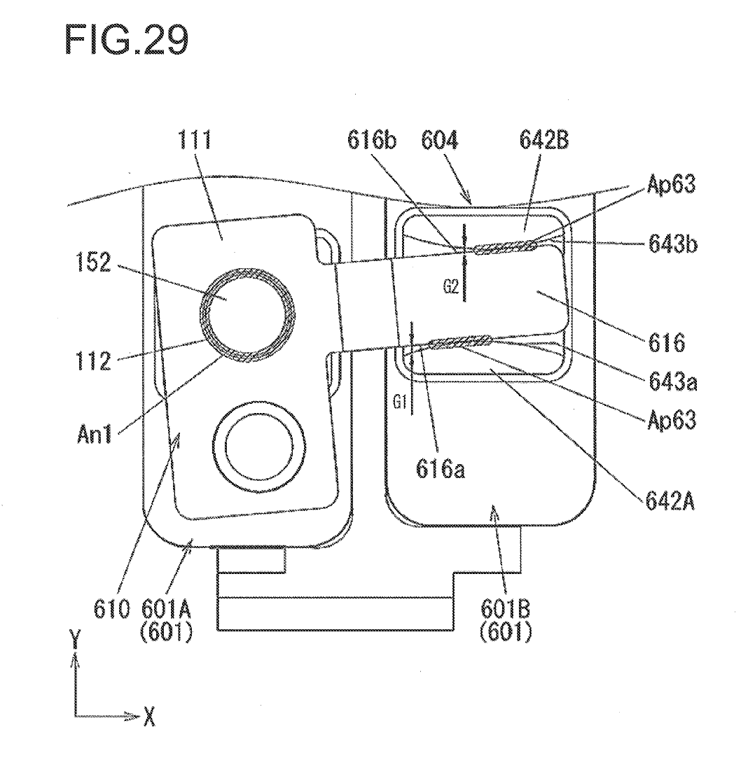

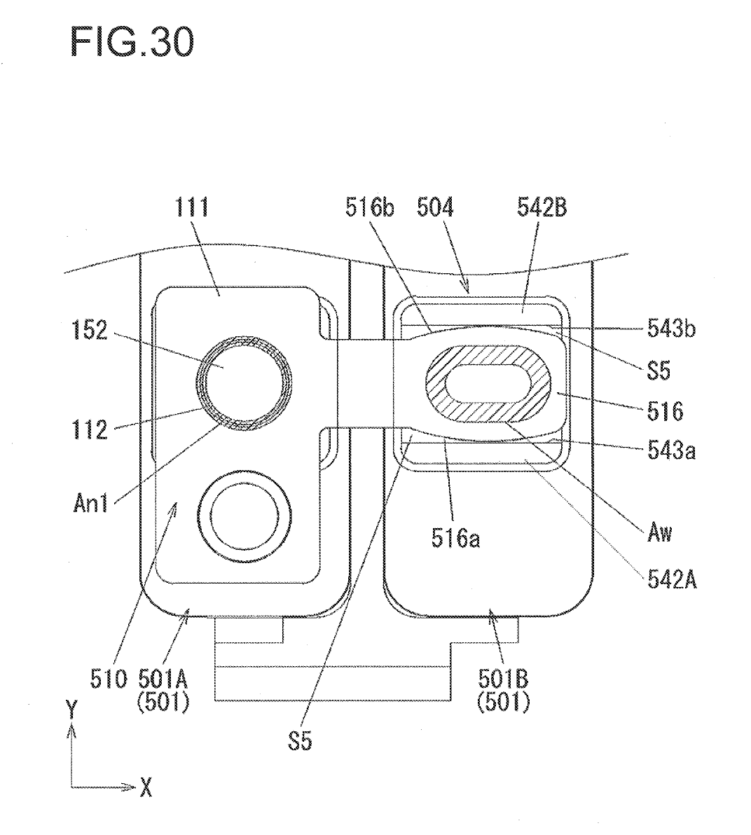

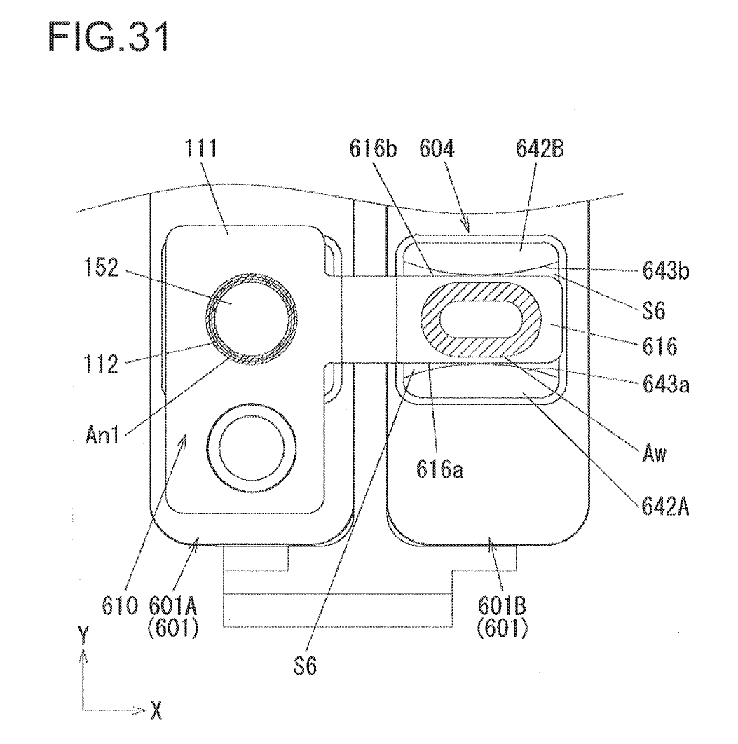

FIG. 1 is a perspective presenting an external view of an assembled battery 100 achieved in the first embodiment, and FIG. 2 is a perspective showing the structure of the assembled battery 100. It is to be noted that the embodiment will be described by referring to the side on which the cell lid where a positive terminal 104 and a negative terminal 105 are disposed is located as an upper side of the assembled battery 100 and referring to the cell bottom surface side as a lower side of the assembled battery 100. The following explanation will be given by referring to the direction running between the upper side and the lower side of the assembled battery 100 as a Z direction, referring to the direction along which a plurality of battery cells 101 constituting the assembled battery 100 are laminated or stacked, i.e., the direction running along the longer sides of the assembled battery 100, as an X direction and referring to a direction running perpendicular to both the X direction and the Z direction, i.e., the direction running along the width of the assembled battery 100, as a Y direction, as indicated in FIG. 1.

As FIG. 1 and FIG. 2 show, the assembled battery 100 includes a plurality of battery cells 101. The plurality of battery cells 101, disposed so as to achieve a laminated or stacked structure, are assembled into an integrated unit via an integrating mechanism configured with a pair of end plates 120, a pair of side frames 121 and a plurality of cell holders 122A and 122B disposed between the individual battery cells 101. Over the plurality of battery cells 101, a top plate 123 is disposed.

The battery cells 101, assuming a flat rectangular parallelepiped shape, are disposed one after another so that a wide side surface 109W (see FIG. 3) with a wide area belonging to a battery cell 101 faces opposite a wide side surface 109W of another battery cell. Any two battery cells 101 to assume positions adjacent to each other are disposed with reverse orientation so that the sides on, which a positive terminal 104 and a negative terminal 105 projecting from a cell lid 108 of one battery cell 101 (see FIG. 3) are located are the reverse of those at the other battery cell 101.

As shown in FIG. 1 and FIG. 2, the positive terminal 104 and the negative terminal 105 of adjacent battery cells 101 are electrically connected with each other via a bus bar 110A, which is a flat conductive member constituted with a metal plate. In other words, the plurality of battery cells 101 constituting the assembled battery 100 achieved in the embodiment are electrically connected in series.

As FIG. 1 shows, a bus bar 110B used to electrically connect the assembled battery 100 to another assembled battery (not shown) or to a power extraction wiring (not shown) is mounted at the positive terminal 104 of one of the battery cells 101 disposed at the two ends (the battery cell 101 at the left end in the figure). At the negative terminal 105 of the other battery cell 101 (the battery cell 101 at the right end in the figure) of the two battery cells 101 disposed at the two ends, a bus bar 110C, used to electrically connect the assembled battery 100 to another assembled battery (not shown) or to a power extraction wiring (not shown), is mounted.

As shown in FIG. 1 and FIG. 2, intermediate cell holders 122A are each disposed between two battery cells 101, whereas end cell holders 122B are each disposed between the battery cell 101 at one of the two ends and the corresponding end plate 120. The plurality of battery cells 101 in the laminated structure are held by the cell holders 122A and 122B and are further held in place between the pair of end plates 120 disposed on the two sides facing opposite each other along the X direction. The end plates 120 are flat rectangular plates assuming a shape corresponding to that of the wide side surfaces 109W (see FIG. 3) of the battery cells 101.

The intermediate cell holders 122A and the end cell holders 120B are constituted of a resin material having an insulating property. At the side surfaces of the cell holders 122A and 122B, projecting portions 122c, projecting out along the Y direction, are formed.

The plurality of battery cells 101 and the cell holders 122A and 122B, held in place between the pair of end plates 120, are firmly bundled by the pair of side frames 121. The pair of side frames 121 are disposed on the two sides facing opposite each other along the Y direction. The pair of side frames 121 each includes a pair of flanges 121f disposed at the two ends facing opposite each other along the X direction and an opening portion 121c located between the pair of flanges 121f. Through holes 121h are formed at each flange 121f, whereas screw holes 120h are formed at each end plate 120.

The opening portion 121c at the side frame 121 is set, from the outer side along the Y direction, so as to fit over the projecting portions 122c of the cell holders 122A and 122B. The two end edges of the opening portion 121c facing opposite each other along the X direction engage with projecting portions 120c projecting along the Y direction from the sides of the end plates 120. The flanges 121f are set in contact with the end plates 120.

Locking screws (fastening members) are inserted through the through holes 121h at the side frames 121 from the outer side of the end plates 120 along the X direction and the locking screws are threaded through the screw holes 120h at the end plates 120, so as to mount the side frames 121 to the end plates 120. Through this process, the cell holders 122A and 122B held in place between the pair of end plates 120 become compressed by a predetermined extent and the battery cells 101 become held in place between the end plates 120 via the individual cell holders 122A and 122B.

Since the cell holders 122A and 122B, constituted of an insulating material, are disposed between the individual battery cells 101 and between the end plates 120 and the battery cells 101, good insulation is assured and the positions taken by the individual battery cells 101 relative to one another are regulated.

As shown in FIG. 2, openings 123h, through which the positive terminals 104 and the negative terminals 105 of the battery cells 101 are inserted, are formed at the top plate 123 at positions corresponding to the positions at which the bus bars 110A, 110B and 110C are to be mounted. As FIG. 1 and FIG. 2 indicate, guide plates 123a assuming shapes corresponding to those of the bus bars 110A, 110E and 110C are disposed in the vicinity of the openings 123h at the top plate 123 so as to facilitate positioning of the bus bars 110A, 110B and 1100 relative to the positive terminals 104 and the negative terminals 105.

The battery cells 101 constituting the assembled battery 100 will be described next. The plurality of battery cells 101 are structurally identical to one another. FIG. 3 shows a battery cell 101 in a perspective.

As FIG. 3 shows, the battery cell 101 includes a prismatic cell container made up with a cell case 109 and the cell lid 108. The cell case 109 and the cell lid 108 are both constituted of aluminum. The cell case 109 takes on the shape of a rectangular box with an opening 109A located at one end thereof. The cell lid 108 is a rectangular plate, laser-welded so as to close off the opening 109A of the cell case 109. In other words, the cell lid 108 seals off the cell case 109.

The cell container is a hollow rectangular parallelepiped member. Wide side surfaces 109W ranging over a great width face opposite each other, and narrow side surfaces 109N ranging over a small width face opposite each other. The cell lid 108 and a bottom surface 109B of the cell case 109 face opposite each other.

Inside the cell container, a charge/discharge element (not shown), shielded with an insulating case (not shown), is housed. A positive electrode of the charge/discharge element (not shown) is connected to the positive terminal 104, whereas a negative electrode of the charge/discharge element is connected to the negative terminal 105. Thus, power is provided via the positive terminal 104 and the negative terminal 105 to an external device or power generated at an external device is provided via the positive terminal 104 and the negative terminal 105 to charge the charge/discharge element.

At the cell lid 108, an electrolyte port, through which an electrolytic solution is poured into the cell container, is formed. Once the cell container is filled with the electrolytic solution, the electrolyte port is sealed off with an electrolyte plug 108A. The electrolytic solution to be poured into the cell container may be, for instance, a non-aqueous electrolytic solution with lithium salt, such as lithium hexafluorophosphate (LiPf₆), dissolved in a carbonic acid ester-type organic solvent such as ethylene carbonate.

A gas release vent 108B is disposed at the cell lid 108. The gas release vent 108B is formed by thinning part of the cell lid 108 through press-machining. It is to be noted that a thin-film member may be mounted at an opening of the cell lid 108 formed through laser welding or the like and the thin-film portion can function as a gas release vent. As the pressure in the cell container rises due to gas generated as a result of heat caused by an abnormality such as an overcharge of the battery cell 101, and reaches a level equal to a predetermined pressure, the gas release vent 108B ruptures so as to release the gas from the cell container and lower the pressure in the cell container.

FIG. 4 shows the negative terminal 105 of a battery cell (hereafter referred to as a first battery cell 101A) among the plurality of battery cells 101, the positive terminal 104 of another battery cell (hereafter referred to as a second battery cell 101B) disposed adjacent to the first battery cell 101A and a bus bar 110A in a perspective, and FIG. 5 is a schematic side elevation presenting a view taken from one side along the Y direction in FIG. 4. In FIG. 5, the bus bar 110A is shown in a sectional view taken through line V-V in FIG. 4.

As FIG. 4 shows, the negative terminal 105, constituted of copper or a copper alloy, includes a negative base portion 151 assuming a substantially rectangular parallelepiped shape and an axial portion 152, assuming the shape of a circular column, which projects upward from the upper surface of the negative base portion 151. The upper surface of the negative base portion 151 is a flat surface with which the bus bar 110A comes in contact. The positive terminal 104, constituted of aluminum or an aluminum alloy, includes a positive base portion 141 assuming a substantially rectangular parallelepiped shape and a projecting portion 142 projecting upward from the top surface of the positive base portion 141. The upper surface of the positive base portion 141 is a flat surface with which the bus bar 110A comes in contact. The projecting portion 142 assumes a columnar shape with a substantially rectangular section, with the four corners thereof somewhat rounded, and is formed so that the longer sides of the rectangle run parallel to the X direction.

The bus bar 110A assumes a substantially L shape in a plan view (see FIG. 6(a)). As FIG. 4 shows, the bus bar 110A includes a negative connection portion 111, taking the shape of a substantially rectangular plate, which is set in contact with the upper surface of the negative base portion 151 of the first battery cell 101A, a positive connection portion 116, taking the shape of a substantially square plate, which is set in contact with the upper surface of the positive base portion 141 of the second battery cell 101B, and a linking portion 115 that links the negative connection portion 111 and the positive connection portion 116 to each other. As indicated in FIG. 4 and FIG. 5, the linking portion 115, viewed from one side along the Y direction, takes on an inverted U-shape, and is allowed to extend/contract freely along the X direction through elastic deformation. One of the two ends of the linking portion 115, facing opposite each other along the X direction, is connected to a longer side of the negative connection portion 111, whereas the other end is connected to one side of the positive connection portion 116.

A voltage detection connector terminal 113, to which a voltage detection line (not shown) is connected to enable detection of the voltage at the battery cell 101, is disposed at the negative connection portion 111. A round fitting hole 112, to be fitted around the axial portion 152 of the negative terminal 105, is formed at the negative connection portion 111. At the positive connection portion 116, an opening portion 117 to be fitted around the projecting portion 142 at the positive terminal 104, is formed.

As FIG. 5 shows, a thickness tn of the negative connection portion 111 is set substantially equal to a height hn of the axial portion 152 at the negative terminal 105 (tn≈hn). A thickness tp of the positive connection portion 116 is set substantially equal to a height hp of the projecting portion 142 at the positive terminal 104 (tp≈hp).

The end of the fitting hole 112, located on the lower surface side, at the negative connection portion 111 is chamfered so as to form a tapered area 112t. The end of the opening portion 117, located on the lower surface side, at the positive connection portion 116 is chamfered so as to form a tapered area 117t. The upper end of the axial portion 152 at the negative terminal 105 is chamfered so as to form a tapered area 152t. The upper end of the projecting portion 142 at the positive terminal 104 is chamfered so as to form a tapered area 142t. Through these measures, it is ensured that the axial portion 152 and the projecting portion 142 are inserted through the fitting hole 112 and the opening portion 117 with better ease. It is to be noted that the tapered areas may be formed through R chamfering (corner rounding) instead of C chamfering.

FIG. 6(a) is a schematic plan view of an electrode connecting device configured with the bus bar 110A, the negative terminal 105 of the first battery cell 101 A and the positive terminal 104 of the second battery cell 101B, whereas FIG. 6(b) is a schematic enlargement of the area A in FIG. 6(a). In FIG. 6, the first battery cell 101A and the second battery cell 101B constituting the assembled battery 100 are each disposed at the correct position (hereafter referred to as a reference position). When the first battery cell 101A and the second battery cell 101B are disposed at their reference positions, the first battery cell 101A and the second battery cell 101B are set apart from each other over a predetermined distance along the X direction and the first battery cell 101A and the second battery cell 101B take on matching positions along the Y direction. It is to be noted that for purposes of clarity, the curvatures of a first curved inner surface 117a and a second curved inner surface 117b at the opening portion 117, to be described later, are exaggerated in the figures.

As shown in FIG. 6(a), the fitting hole 112 at the negative connection portion 111 fits around the axial portion 152 of the negative terminal 105 at the first battery cell 101 A so as to allow the axial portion 152 to turn freely over a predetermined rotation range when positioning. The diameter of the fitting hole 112 is slightly greater than the diameter of the axial portion 152. As a result, a small gap is formed between the axial portion 152 and the fitting hole 112.

The projecting portion 142 of the positive terminal 104 at the second battery cell 101B is fitted in the opening portion 117 at the positive connection portion 116. The shape of the projecting portion 142, i.e., the terminal-side fitting portion, is different from the shape of the opening portion 117, i.e., the bus bar-side fitting portion, and they are fitted together with a space S1 formed between the projecting portion 142 and the opening portion 117.

As FIG. 6(b) shows, the projecting portion 142 includes a first flat outer surface 142a and a second flat outer surface 142b ranging parallel to each other. The projecting portion 142 further includes a third flat outer surface 142c and a fourth flat outer surface 142d ranging parallel to each other. The first flat outer surface 142a and the second flat outer surface 142b are set so as to range parallel to the X direction, whereas the third flat outer surface 142c and the fourth flat outer surface 142d are set so as to range parallel to the Y direction.

Via curved surfaces 142r, one end of the first flat outer surface 142a is connected to the third flat outer surface 142c, the other end of the first flat outer surface 142a is connected to the fourth flat outer surface 142d, one end of the second flat outer surface 142b is connected to the third flat outer surface 142c and the other end of the second flat outer surface 142b is connected to the fourth flat outer surface 142d.

The opening portion 117 includes the first curved inner surface 117a facing opposite the first flat outer surface 142a, the second curved inner surface 117b facing opposite the second flat outer surface 142b, a third flat inner surface 117c facing opposite the third flat outer surface 142c and a fourth flat inner surface 117d facing opposite the fourth flat outer surface 142d.

Via curved surfaces 117r, one end of the first curved inner surface 117a is connected to the third flat inner surface 117c, the other end of the first curved inner surface 117a is connected to the fourth flat inner surface 117d, one end of the second curved inner surface 117b is connected to the third flat inner surface 117c and the other end of the second curved inner surface 117b is connected to the fourth flat inner surface 117d.

The dimension of the opening portion 117, measured along the X direction, i.e., the distance between the third flat inner surface 117e and the fourth flat inner surface 117d, is set greater than the dimension of the projecting portion 142 measured along the X direction, i.e., the distance between the third flat outer surface 142c and the fourth flat outer surface 142d.

The first curved inner surface 117a, having an arc shape in plan view, bows out toward the first flat outer surface 142a at the center of the opening 117 taken along the X direction. Namely, the central area of the first curved inner surface 117a bows out toward the first flat outer surface 142a compared to the two ends of the first curved inner surface 117a. Likewise, the second curved inner surface 117b, having an arc shape in plan view, bows out toward the second flat outer surface 142b at the center of the opening 117 taken along the X direction. Namely, the central area of the second curved inner surface 117b bows out further toward the second flat outer surface 142b compared to the two ends of the second curved inner surface 117b.

As indicated in FIG. 6(a), the opening portion 117 takes on a shape achieving line symmetry relative to a center line CLx running through the center of the opening portion 117a taken along the X direction and further achieving line symmetry relative to a center line CLy running through the center of the opening portion 117 taken along the Y direction. As FIG. 6(b) indicates, the opening portion 117 is formed so that the distance between the first curved inner surface 117a and the second curved inner surface 117b, measured along the Y direction, gradually increases, starting from the center line CLx, running through the center of the opening portion 117 taken along the X direction, toward the third flat inner surface 117c and the fourth flat inner surface 117d.

The distance between the first curved inner surface 117a and the second curved inner surface 117b, measured along the Y direction, is at its shortest on the center line CLx running through the center of the opening portion 117 taken along the X direction. This shortest distance is set slightly greater than the dimension of the projecting portion 142 measured along the Y direction, i.e., the distance between the first flat outer surface 142a and the second flat outer surface 142b.

A slight gap is formed between the first flat outer surface 142a of the projecting portion 142 and the first curved inner surface 117a of the opening portion 117. The measurement G1 for this gap takes on a smallest value G1min on the center line CLx running through the center of the opening portion 117 taken along the X direction and gradually increases as the measuring point moves away from the center line CLx running through the center of the opening portion 117 taken along the X direction toward the third flat inner surface 117c or the fourth flat inner surface 117d.

Likewise, a slight gap is formed between the second flat outer surface 142b of the projecting portion 142 and the second curved inner surface 117b of the opening portion 117. The measurement G2 for this gap takes on a smallest value G2min on the center line CLx running through the center of the opening portion 117 taken along the X direction and gradually increases as the measuring point moves away from the center line CLx running through the center of the opening portion 117 taken along the X direction toward the third flat inner surface 117c or the fourth flat inner surface 117d.

The smallest values G1min and G2min taken for the gap measurements G1 and G2 are each set equal to or less than a largest measurement value that allows butt-welding (hereafter referred to as the “allowable weld measurement Gw”), so as to prevent the occurrence of a weld defect. The allowable weld measurement Gw may be, for instance, approximately 10% of the depth of penetration. In the embodiment, the plate thickness of the bus bar 110A is approximately 0.8 mm and the depth of penetration is set to approximately 0.8 mm, and thus, the allowable weld measurement is approximately 0.08 mm. Accordingly, areas over which the gap measurements G1 and G2 are approximately 0 to 0.08 mm can be designated as butt-weld areas Ap11 (see FIG. 7). At the reference position in the present embodiment, the smallest values G1min and G2min taken for the gap measurements G1 and G2 are both approximately 0.04 mm. It is to be noted that the plate thickness of the bus bar 110A and the depth of penetration are not limited to the values given above, but in any case, the allowable weld measurement Gw is set by taking into consideration the plate thickness of the bus bar 110A and the depth of penetration.

Once the bus bar 110A is positioned, the inner surfaces of the opening portion 117 in the bus bar 110A are butt-welded to the outer surfaces of the projecting portion 142 at the positive terminal 104 and the inner circumferential surface at the fitting hole 112 in the bus bar 110A is butt-welded to the outer circumferential surface of the axial portion 152 at the negative terminal 105. FIG. 7 is a schematic plan view showing the butt-weld areas Ap11 where the bus bar 110A and the positive terminal 104 are butt-welded to each other and a butt-weld area An1 where the bus bar 110A and the negative terminal 105 are butt-welded to each other. In a schematic illustration presented in FIG. 7, the butt-weld areas Ap11 and An1 are each indicated as a shaded area.

As FIG. 7 indicates, the positive-side butt-weld areas Ap11 each range to points set apart from the center line CLx, running through the center of the opening portion 117 taken along the X direction, by a predetermined distance. The butt-weld areas Ap11 are areas where the measurement G1 of the gap between the first curved inner surface 117a and the first flat outer surface 142a and the measurement G2 of the gap between the second curved inner surface 117b and the second flat outer surface 142b are equal to or less than the allowable weld measurement Gw. After the bus bar 110A is positioned, butt-welding is performed over the butt-weld areas Ap11, where the gap measurement G1 and the gap measurement G2 are equal to or less than the allowable weld measurement Gw by ensuring that no weld defect occurs.

As shown in FIG. 7, the butt-weld area An1 on the negative side is set over the entire circumference of the axial portion 152. The measurement of the gap between the outer circumferential surface of the axial portion 152 at the negative terminal 105 and the inner circumferential surface at the fitting hole 112 in the negative connection portion 111 may be, for instance, approximately 0.04 mm in the butt-weld area An1. After the bus bar 110 is positioned, butt-welding is performed in the butt-weld area An1 by ensuring that no weld defect occurs.

The embodiment allows the bus bar 110A to be mounted at the positive terminal 104 and the negative terminal 105 so as to butt-weld the bus bar 110A to the positive terminal 104 and butt-weld the bus bar 110A to the negative terminal 105 even when the battery cells 101 are disposed with an offset relative to their reference positions.

The space S1 defined by the inner surfaces of the opening portion 117 and the outer surfaces of the projecting portion 142 is formed over the shaded area in FIG. 6(a). This space S1 absorbs relative displacement of the positive connection portion 116 and the positive terminal 104 when the battery cells 101 are disposed with an offset.

In reference to FIG. 8 and FIG. 9, the workings of the electrode connecting device in the event of an offset of the battery cells 101 relative to their reference positions will be described. FIG. 8 is a schematic plan view showing the second battery cell 101B disposed with an offset relative to the first battery cell 101 A along the laminating direction (X direction). FIG. 9(a) is a schematic plan view showing the second battery cell 101B disposed with an offset relative to the first battery cell 101A along the widthwise direction (Y direction), with FIG. 9(b) showing the positive-side fitting area in a schematic enlargement.

As FIG. 6(a) shows, the dimensions of the opening portion 117 measured along the X direction (the measurement taken along the longer sides of the opening portion 117) is greater than the dimension of the projecting portion 142 measured along the X direction (measured along the longer sides of the projecting portion 142), and the space S1 is defined by the inner surfaces of the opening portion 117 and the outer surfaces of the projecting portion 142. Thus, if the second battery cell 101B is disposed with an offset relative to the first battery cell 101A toward one side (to the right in the figure) from the reference position along the laminating direction (X direction), the bus bar 110A is mounted with the projecting portion 142 set toward the fourth flat inner surface 117d of the opening portion 117, as indicated in FIG. 8.

In the embodiment, butt-weld areas Ap12 where the gap measurement G1 and the gap measurement G2 are equal to or less than the allowable weld measurement Gw can be secured even when the second battery cell 101B is offset along the X direction. Thus, butt-welding can be performed in the butt-weld areas Ap12 by ensuring that no weld defect occurs.

It is to be noted that although not shown, when the second battery cell 101B is disposed with an offset relative to the first battery cell 101A toward the other side (to the left in the figure) from the reference position along the laminating direction (X direction), too, the relative displacement of the positive connection portion 116 and the positive terminal 104 is absorbed in the space S1, allowing the bus bar 110A to be disposed at a position at which it can be butt-welded to the positive terminal 104.

As indicated in FIG. 9(a), if the second battery cell 101B is disposed with an offset relative to the first battery cell 101A toward one side (upward in the figure) from the reference position along the widthwise direction (Y direction), the bus bar 110A mounted over the battery cells is rotated relative to the reference position by a specific angle around the axial portion 152 of the negative terminal 105 forming the rotational center. In this situation, the position at which the measurement G1 of the gap between the first curved inner surface 117a and the first flat outer surface 142a takes on a smallest value G1min′ is offset toward the fourth flat outer surface 142d from a center line CLx′ running through the center of the projecting portion 142 taken along the X direction, as indicated in FIG. 9(b). The position at which the measurement G2 of the gap between the second curved inner surface 117b and the second flat outer surface 142b takes on a smallest value G2min′ is offset toward the third flat outer surface 142c from the center line CLx′ running through the center of the projecting portion 142 taken along the X direction.

When the bus bar 110A is mounted with a tilt at a specific angle relative to the reference position, a distance Ly1 between a tangential plane L11 at the first curved inner surface 117a and a tangential plane L12 at the second inner curved surface 117b, ranging respectively parallel to the first flat outer surface 142a and the second flat outer surface 142b, is greater than a distance Wy1 between the first flat outer surface 142a and the second flat outer surface 142b of the projecting portion 142. Thus, even though the bus bar 110A is tilted, the opening portion 117 can be fitted around the projecting portion 142.

As shown in FIG. 6, even when the second battery cell 101B is disposed with an offset relative to the first battery cell 101A toward one side (upward in the figure) along the Y direction, butt-weld areas Ap13 where the gap measurement G1 and the gap measurement G2 are equal to or less than the allowable weld measurement Gw are formed, making it possible to perform butt-welding by ensuring that no weld defect occurs.

The angular range over which the bus bar 110A in a tilted state can still be mounted at the positive terminal 104 and the negative terminal 105, i.e., the rotational range over which the bus bar 110A can be mounted in a rotated state, is determined based upon the curvatures of the first curved inner surface 117a and the second curved inner surface 117b and the measurement of the opening portion 117 taken along its longer sides. By assuming greater curvatures for the first curved inner surface 117a and the second curved inner surface 117b and a greater measurement for the opening portion 117 along the longer sides thereof, the angular range over which the bus bar 110A can be mounted with a tilt is widened. It is to be noted that while the extent of offset that can be tolerated can be increased by assuming greater curvatures, butt-weld areas that can be secured over curved inner surfaces with greater curvatures are bound to be smaller. In contrast, while the butt-weld areas can be increased by assuming smaller curvatures, the extent of offset that can be tolerated in conjunction with smaller curvatures is bound to decrease. The electric resistance can be reduced to a greater extent in a larger butt-weld area. Accordingly, the curvatures of the first curved inner surface 117a and the second curved inner surface 117b are set by taking into consideration the extent of offset of battery cells 101 expected to occur during the process of assembling the assembled battery 100 and the required size of the butt-weld areas.

It is to be noted that although not shown, when the second battery cell 101B is disposed with an offset relative to the first battery cell 101A toward the other side (downward in the figure) from the reference position along the widthwise direction (Y direction), too, the relative displacement of the positive connection portion 116 and the positive terminal 104 is absorbed in the space S1, allowing the bus bar 110A to be disposed at a position at which it can be butt-welded to the positive terminal 104.

Furthermore, although not shown, even when the second battery cell 101B is offset relative to the first battery cell 101A by a specific distance from the reference position along the X direction and also by a specific distance from the reference position along the Y direction, too, the bus bar 110A can be positioned so as to achieve a butt-welding enabled state by fitting the fitting hole 112 in the bus bar 110A around the axial portion 152 of the negative terminal 105 and fitting the opening portion 117 in the bus bar 110A around the projecting portion 142 of the positive terminal 104.

The following advantages are achieved through the first embodiment described above.

(1) The electrode connecting device configured with the bus bar 110A, the negative terminal 105 of the first battery cell 101A and the positive terminal 104 of the second battery cell 101B includes a space forming portion made up with the projecting portion 142, which is a terminal-side fitting portion, and the opening portion 117, which is a bus bar-side fitting portion. With the space forming portion, the space S1 where relative displacement of the positive connection portion 116 and the positive terminal 104 is absorbed when the second battery cell 101B is disposed with an offset from its reference position along the X direction and/or the Y direction relative to the first battery cell 101A, is formed. Thus, even if the second battery cell 101B is disposed with an offset from its reference position relative to the first battery cell 101A, the bus bar 110A can be set at a position at which it can be butt-welded simply by fitting the fitting hole 112 in the bus bar 110A around the axial portion 152 of the negative terminal 105 and fitting the opening portion 117 in the bus bar 110A around the projecting portion 142 of the positive terminal 104. As a result, even when there is a positional misalignment between the battery cells 101, the curved inner surfaces 117a and 117b of the opening portion 117 in the bus bar 110A can be butt-welded to the flat outer surfaces 142a and 142b of the projecting portion 142 at the positive terminal 104 so as to suppress the occurrence of weld defect.

In contrast, the related art disclosed in PTL 1 requires the bus bar to be pressed so as to alter the shape of the bus bar, resulting in a laborious mounting process. The embodiment described above, which does not require pressure to be applied to the bus bar 110A, allows the bus bar 110A to be connected to the negative terminal 105 and the positive terminal 104 with the bus bar 110A positioned with ease even when the battery cells 101 are misaligned. Since this improves the ease of manufacturing, the manufacturing costs can be lowered.

(2) On the negative side, where the axial portion 152, having the shape of a circular column, is fitted in the circular fitting hole 112 and the axial portion 152 is butt-welded at the fitting hole 112 over its entire circumference, the voltage detection connector terminal 113 is disposed at the negative connection portion 111. Since the axial portion 152 is butt-welded over its entire circumference, a greater weld area is achieved on the negative side compared to the positive side. As a result, the connection resistance on the negative side can be lowered in comparison to the connection resistance on the positive side. Furthermore, the negative terminal 105 is constituted of a material such as copper or a copper alloy having lower electrical resistance compared to the electrical resistance of aluminum or aluminum alloy used to form the positive terminal 104. Thus, by disposing the voltage detection connector terminal 113 at the negative connection portion 111 rather than at the positive connection portion 116, the voltage at the particular battery cell 101 A can be detected with better stability and accuracy.

### Variation of the First Embodiment

In reference to FIG. 10, an electrode connecting device for an assembled battery, achieved as a variation of the first embodiment, will be described. It is to be noted that the following description will focus on a feature differentiating the variation from the first embodiment with the same reference signs assigned to elements identical to or equivalent to those in the first embodiment. In the first embodiment described above, the outer circumferential surface of the axial portion 152 in the negative terminal 105 and the inner circumferential surface of the fitting hole 112 in the negative connection portion 111 at the bus bar 110A are butt-welded together. In the variation of the first embodiment, the negative connection portion 111 in the bus bar 110A is fastened to the negative terminal 105 via a screw 190, instead of through butt-welding.

As shown in FIG. 10, a female threaded portion 191 which interlocks with the screw 190 is formed at the axial portion 152 of the negative terminal 105. Once the bus bar 110A is positioned with the fitting hole 112 in the negative connection portion 111 fitted around the axial portion 152 and the opening portion 117 in the positive connection portion 116 fitted around the projecting portion 142, the screw 190 is screwed into the female threaded portion 191 so as to fasten the negative connection portion 111 to the negative terminal 105. It is to be noted that the positive connection portion 116 and the positive terminal 104 are butt-welded together as in the first embodiment.

This variation of the first embodiment allows the bus bar 110A to be connected to the negative terminal 105 and the positive terminal 104 with the bus bar 110A positioned with ease even when the battery cells 101 are misaligned, as does the first embodiment. Since this improves the ease of manufacturing, the manufacturing costs can be lowered.

### Second Embodiment

In reference to FIGS. 11 through 13, an assembled battery achieved in the second embodiment of the present invention will be described. It is to be noted that the following description will focus on features of the embodiment differentiating it from the first embodiment with the same reference signs assigned to elements in the figures that arc identical to or equivalent to those in the first embodiment. FIG. 11 shows the electrode connecting device for the assembled battery achieved in the second embodiment in a schematic plan view. FIG. 11, which is similar to FIG. 7, shows a battery cell (a first battery cell 201A) and another battery cell (a second battery cell 201B) adjacent to the first battery cell 201A, among battery cells constituting the assembled battery, disposed at the respective reference positions. It is to be noted that for purposes of clarity, the curvatures of a first curved outer surface 242a and a second curved outer surface 242b at a projecting portion 242, to be described later, are exaggerated in the figures.

In the first embodiment, a pair of flat surfaces 142a and 142b both ranging parallel along the X direction are formed at the projecting portion 142 used as the terminal-side fitting portion at the positive terminal 104 and a pair of curved surfaces 117a and 117b respectively facing opposite the pair of flat surfaces 142a and 142b are formed at the opening portion 117 used as the bus bar-side fitting portion at the bus bar 110A.

The second embodiment is distinguishable from this in that a pair of flat surfaces 217a and 217b, ranging parallel along the X direction, are formed at an opening portion 217 used as the bus bar-side fitting portion at a bus bar 210 and curved surfaces 242a and 242b respectively facing opposite that pair of flat surfaces 217a and 217b are formed at the projecting portion 242 used as the terminal-side fitting portion at a positive terminal 204.

As shown in FIG. 11, the opening portion 217 having a rectangular shape is formed in a positive connection portion 216 at the bus bar 210. The opening portion 217 is formed so that the pair of flat surfaces 217a and 217b both run parallel along the X direction when the bus bar 210 is mounted at the reference position.

The first curved outer surface 242a of the projecting portion 242 is formed so as to face opposite the first flat inner surface 217a of the opening portion 217, whereas the second curved outer surface 242b of the projecting portion 242 is formed so as to face opposite the second flat inner surface 217b of the opening portion 217.

The first curved outer surface 242a bows out toward the first flat inner surface 217a at the center of the projecting portion 242 taken along the X direction. Namely, the central area of the second curved outer surface 242b bows out further toward the first flat inner surface 217a compared to the two ends of the first curved outer surface 242a. The second curved outer surface 242b bows out toward the second flat inner surface 217b at the center of the projecting portion 242 taken along the X direction. Namely, the central area of the second curved outer surface 242b bows out further toward the second flat inner surface 217b compared to the two ends of the second curved outer surface 242b.

The two ends of the first curved outer surface 242a of the projecting portion 242 are connected with the two ends of the second curved outer surface 242b via flat surfaces ranging parallel to each other along the Y direction. The dimension of the projecting portion 242, measured along the X direction, is set smaller than the dimension of the opening portion 217 measured along the X direction.

A measurement G1 for the gap formed between the first flat inner surface 217a and the first curved outer surface 242a assumes a smallest value on a center line CLx′ running through the center of the projecting portion 242 taken along the X direction. The gap measurement G1 takes a greater value further away from the center line CLx′ running through the center taken along the X direction. Likewise, a measurement G2 for the gap formed between the second flat inner surface 217b and the second curved outer surface 242b assumes a smallest value on the center line CLx′ running through the center of the projecting portion 242 taken along the X direction. The gap measurement G2 takes a greater value further away from the center line CLx′ running through the center taken along the X direction.

Butt-weld areas Ap21 are designated as areas where the gap measurement G1 and the gap measurement G2 are equal to or less than the allowable weld measurement Gw.

A space S2 is defined with the inner surfaces of the opening portion 217 and the outer surfaces of the projecting portion 242 formed as described above. Relative displacement of the positive connection portion 216 and the positive terminal 204 is thus absorbed to allow them to be butt-welded together even when the second battery cell 201B is disposed with an offset relative to the first battery cell 201A along the X direction or the second battery cell 201B is disposed with an offset relative to the first battery cell 201A along the Y direction.

FIG. 12 is a schematic plan view showing the second battery cell 201B disposed with an offset relative to the first battery cell 201A along the laminating direction (X direction), whereas FIG. 13 is a schematic plan view showing the second battery cell 201B disposed with an offset relative to the first battery cell 201A along the widthwise direction (Y direction).

The dimension of the opening portion 217 measured along the X direction is greater than the dimension of the projecting portion 242 measured along the X direction, and the space S2 is defined by the inner surfaces of the opening portion 217 and the outer surfaces of the projecting portion 242. Thus, if the second battery cell 201B is disposed with an offset relative to the first battery cell 201A toward one side (to the right in the figure) from the reference position along the laminating direction (X direction), the bus bar 210A is mounted with the projecting portion 242 set toward one end of the opening portion 217 along the X direction, as indicated in FIG. 12.

Butt-weld areas Ap22 where the gap measurement G1 and the gap measurement G2 are equal to or less than the allowable weld measurement Gw can be secured even when the second battery cell 201B is offset from the reference position along the X direction relative to the first battery cell 201 A. Thus, butt-welding can be performed in the butt-weld areas Ap22 by ensuring that no weld defect occurs.

It is to be noted that although not shown, when the second battery cell 201B is disposed with an offset relative to the first battery cell 201A toward the other side (to the left in the figure) from the reference position along the laminating direction (X direction), too, the relative displacement of the positive connection portion 216 and the positive terminal 204 is absorbed in the space S2, allowing the bus bar 210 to be disposed at a position at which it can be butt-welded to the positive terminal 204.

As indicated in FIG. 13, if the second battery cell 201B is disposed with an offset from the reference position along the widthwise direction (Y direction) relative to the first battery cell 201A, the bus bar 210 mounted over the battery cells is rotated relative to the reference position by a specific angle around the axial portion 152 of the negative terminal 105 forming the rotational center, as indicated in FIG. 13. In this situation, the position at which the measurement G1 of the gap between the first flat inner surface 217a and the first curved outer surface 242a takes on a smallest value G1min′ is offset toward one end along the X direction (to the right in the figure) from the center line CLx′ running through the center of the projecting portion 242 taken along the X direction. The position at which the measurement G2 of the gap between the second flat inner surface 217b and the second curved outer surface 242b takes on a smallest value G2min′ is offset toward the other end along the X direction (to the left in the figure) from the center line CLx′ running through the center of the projecting portion 242 taken along the X direction.

When the bus bar 210 is mounted with a tilt at a specific angle relative to the reference position, a distance Ly2 between a tangential plane L21 at the first curved outer surface 242a and a tangential plane L22 at the second curved outer surface 242b, ranging respectively parallel to the first flat inner surface 217a and the second flat inner surface 217b, is smaller than a distance Wy2 between the first flat inner surface 217a and the second flat inner surface 217b of the opening portion 217. Thus, even though the bus bar 210 is tilted, the opening portion 217 can be fitted around the projecting portion 242.

Even when the second battery cell 201E is disposed with an offset relative to the first battery cell 201A toward one side (upward in the figure) along the Y direction, butt-weld areas Ap23 where the gap Measurement G1 and the gap measurement G2 are equal to or less than the allowable weld measurement Gw are formed, making it possible to perform butt-welding by ensuring that no weld defect occurs. By forming the first curved outer surface 242a and the second curved outer surface 242b so as to achieve greater curvatures, the extent of offset that can be tolerated can be increased, whereas by forming the curved outer surfaces with smaller curvatures, the butt-weld areas can be increased.

It is to be noted that although not shown, when the second battery cell 201B is disposed with an offset relative to the first battery cell 201A toward the other side (downward in the figure) from the reference position along the widthwise direction (Y direction), too, the relative displacement of the positive connection portion 216 and the positive terminal 204 is absorbed in the space S2, allowing the bus bar 210 to be disposed at a position at which it can be butt-welded to the positive terminal 204.

Furthermore, although not shown, even when the second battery cell 201B is offset relative to the first battery cell 201A by a specific distance from the reference position along the X direction and also by a specific distance from the reference position along the Y direction, too, the bus bar 210 can be positioned so as to achieve a butt-welding enabled state by fitting the fitting hole 112 in the bus bar 210 around the axial portion 152 of the negative terminal 105 and fitting the opening portion 217 in the bus bar 210 around the projecting portion 242 of the positive terminal 204.

The second embodiment described above allows the bus bar 210 to be connected to the negative terminal 105 and the positive terminal 204 with the bus bar 210 positioned with ease even when the battery cells 201 are misaligned, as does the first embodiment. Since this improves the ease of manufacturing, the manufacturing costs can be lowered.

### Variation of the Second Embodiment

In reference to FIG. 14, an electrode connecting device for an assembled battery, achieved as a variation of the second embodiment, will be described. It is to be noted that the following description will focus on a feature differentiating the variation from the second embodiment with the same reference signs assigned to elements identical to or equivalent to those in the second embodiment. In the second embodiment, the outer circumferential surface of the axial portion 152 in the negative terminal 105 and the inner circumferential surface of the fitting hole 112 in the negative connection portion 111 at the bus bar 210 are butt-welded together. In the variation of the second embodiment, the negative connection portion 111 in the bus bar 210 is fastened to the negative terminal 105 via a screw 190, instead of through butt-welding.

As shown in FIG. 14, a female threaded portion 191 which interlocks with the screw 190 is formed at the axial portion 152 of the negative terminal 105. Once the bus bar 210 is positioned with the fitting hole 112 in the negative connection portion 111 fitted around the axial portion 152 and the opening portion 217 in the positive connection portion 216 fitted around the projecting portion 242, the screw 190 is screwed into the female threaded portion 191 so as to fasten the negative connection portion 111 to the negative terminal 105. It is to be noted that the positive connection portion 216 and the positive terminal 204 are butt-welded together as in the second embodiment.

This variation of the second embodiment allows the bus bar 210 to be connected to the negative terminal 105 and the positive terminal 204 with the bus bar 210 positioned with ease even when the battery cells 201 are misaligned, as does the second embodiment.

### Third Embodiment

In reference to FIGS. 15 through 17, an assembled battery achieved in the third embodiment of the present invention will be described. It is to be noted that the following description will focus on features of the embodiment differentiating it from the second embodiment with the same reference signs assigned to elements in the figures that are identical to or equivalent to those in the second embodiment. FIG. 15 shows the electrode connecting device for the assembled battery achieved in the third embodiment in a schematic plan view. FIG. 15, which is similar to FIG. 11, shows a battery cell (a first battery cell 301A) and another battery cell (a second battery cell 301B) adjacent to the first battery cell 301A, among battery cells constituting the assembled battery, disposed at the respective reference positions.

The third embodiment includes a projecting portion 342 formed so as to achieve the shape of a circular column and an opening portion 317 formed so as to achieve the shape of a race track in a plan view. In other words, the projecting portion 342 and the opening portion 317 in the third embodiment take shapes different from those in the second embodiment.

As in the second embodiment, a pair of flat surfaces 317a and 317b, both ranging parallel to each other along the X direction, are formed at the opening portion 317 as a bus bar-side fitting portion of a bus-bar 310 in the third embodiment. The projecting portion 342, formed as a terminal-side fitting portion at a positive terminal 304 includes curved surfaces achieving a circular shape in plan view. In other words, the projecting portion 342 includes a pair of curved surfaces 342a and 342b defined as two separate curved surfaces by a central axis CLy′ running through the center Of the projecting portion 342 taken along the Y direction. The pair of curved surfaces 342a and 342b respectively face opposite the pair of flat surfaces 317a and 317b.

Butt-weld areas Ap31 are areas where the measurement G1 of the gap between the flat surface 317a and the curved surface 342a and the measurement G2 of the gap between the flat surface 317b and the curved surface 342b are equal to or less than the allowable weld measurement Gw.

FIG. 16 is a schematic plan view showing the second battery cell 301B disposed with an offset relative to the first battery cell 301A along the laminating direction (X direction). FIG. 17(a) is a schematic plan view showing the second battery cell 301B disposed with an offset relative to the first battery cell 301A along the widthwise direction (Y direction), and FIG. 17(b) presents a schematic enlargement of the positive-side fitting portion.

The dimension of the opening portion 317 measured along the X direction is greater than the dimension of the projecting portion 342 taken along the X direction, and a space S3 is defined by the inner surfaces of the opening portion 317 and the outer surfaces of the projecting portion 342 (see FIG. 15). Thus, if the second battery cell 301B is disposed with an offset relative to the first battery cell 301A toward one side (to the right in the figure) from the reference position along the laminating direction (X direction), the bus bar 310 is mounted with the projecting portion 342 set toward one end of the opening portion 317 along the X direction, as indicated in FIG. 16.

Butt-weld areas Ap32 where the gap measurement G1 and the gap measurement G2 are equal to or less than the allowable weld measurement Gw can be secured even when the second battery cell 301B is offset from the reference position along the X direction relative to the first battery cell 301A. Thus, butt-welding can be performed in the butt-weld areas Ap32 by ensuring that no weld defect occurs.

It is to be noted that although not shown, when the second battery cell 301B is disposed with an offset relative to the first battery cell 301 A toward the other side (to the left in the figure) from the reference position along the laminating direction (X direction), too, the relative displacement of a positive connection portion 316 and the positive terminal 304 is absorbed in the space S3, allowing the bus bar 310 to be disposed at a position at which it can be butt-welded to the positive terminal 304.

As indicated in FIG. 17(a), if the second battery cell 301B is disposed with an offset relative to the first battery cell 301A toward one side (upward in the figure) from the reference position along the widthwise direction (Y direction), the bus bar 310A mounted is rotated relative to the reference position by a specific angle around the axial portion 152 of the negative terminal 105 forming the rotational center. As indicated in FIG. 17(b), in this situation, the position at which the measurement G1 of the gap between the flat surface 317a and the curved surface 342a takes on a smallest value G1min′ is offset toward one end along the X direction (to the right in the figure) from a center line CLx′ running through the center of the projecting portion 342 taken along the X direction. The position at which the measurement G2 of the gap between the flat surface 317b and the curved surface 342b takes on a smallest value G2min′ is offset toward the other end along the X direction (to the left in the figure) from the center line CLx′ running through the center of the projecting portion 342 taken along the X direction.

Even when the second battery cell 301B is disposed with an offset relative to the first battery cell 301A toward one side (upward in the figure) along the Y direction, butt-weld areas Ap33 where the gap measurement G1 and the gap measurement G2 are equal to or less than the allowable weld measurement Gw are formed, making it possible to perform butt-welding by ensuring that no weld defect occurs. Greater curvatures are achieved compared to those in the second embodiment at the curved surfaces 342a and 342b respectively facing opposite the flat surfaces 317a and 317b and thus, the extent of offset the can be tolerated in the third embodiment is increased.

It is to be noted that although not shown, when the second battery cell 301B is disposed with an offset relative to the first battery cell 301A toward the other side (downward in the figure) from the reference position along the widthwise direction (Y direction), too, the relative displacement of the positive connection portion 316 and the positive terminal 304 is absorbed in the space S3, allowing the bus bar 310 to be disposed at a position at which it can be butt-welded to the positive terminal 304.

Furthermore, although not shown, even when the second battery cell 301B is dispose with an offset relative to the first battery cell 301A by a specific distance from the reference position along the X direction and also by a specific distance from the reference position along the Y direction, too, the bus bar 310 can be positioned so as to achieve a butt-welding enabled state by fitting the fitting hole 112 in the bus bar 310 around the axial portion 152 of the negative terminal 105 and fitting the opening portion 317 in the bus bar 310 around the projecting portion 342 of the positive terminal 304.

The third embodiment allows the bus bar 310 to be connected to the negative terminal 105 and the positive terminal 304 with the bus bar 310 positioned with ease even when the battery cells 301 are misaligned, as does the second embodiment. Since this improves the ease of manufacturing, the manufacturing costs can be lowered.

### Variation of the Third Embodiment

In reference to FIG. 18, an electrode connecting device for an assembled battery, achieved as a variation of the third embodiment, will be described. It is to be noted that the following description will focus on a feature differentiating the variation from the third embodiment with the same reference signs assigned to elements identical to or equivalent to those in the third embodiment. In the third embodiment, the outer circumferential surface of the axial portion 152 in the negative terminal 105 and the inner circumferential surface of the fitting hole 112 in the negative connection portion 111 at the bus bar 310 are butt-welded together. In the variation of the third embodiment, the negative connection portion 111 in the bus bar 310 is fastened to the negative terminal 105 via a screw 190, instead of through butt-welding.

As shown in FIG. 18, a female threaded portion 191 which interlocks with the screw 190 is formed at the axial portion 152 of the negative terminal 105. Once the bus bar 310 is positioned with the fitting hole 112 in the negative connection portion 111 fitted around the axial portion 152 and the opening portion 317 in the positive connection portion 316 fitted around the projecting portion 342, the screw 190 is screwed into the female threaded portion 191 so as to fasten the negative connection portion 111 to the negative terminal 105. It is to be noted that the positive connection portion 316 and the positive terminal 304 are butt-welded together as in the third embodiment.

This variation of the third embodiment allows the bus bar 310 to be connected to the negative terminal 105 and the positive terminal 304 with the bus bar 310 positioned with ease even when the battery cells 301 are misaligned, as does the third embodiment.

### Fourth Embodiment

In reference to FIGS. 19 and 20, an assembled battery achieved in the fourth embodiment of the present invention will be described. It is to be noted that the following description will focus on features of the embodiment differentiating it from the third embodiment with the same reference signs assigned to elements in the figures that are identical to or equivalent to those in the third embodiment. FIG. 19 shows the electrode connecting device for the assembled battery achieved in the fourth embodiment in a schematic plan view. FIG. 19, which is similar to FIG. 15, shows a battery cell (a first battery cell 401A) and another battery cell (a second battery cell 401B) adjacent to the first battery cell 401 A, among battery cells constituting the assembled battery, disposed at the respective reference positions.

The pair of flat surfaces 317a and 317b, both ranging parallel along the X direction, are formed at the opening portion 317 (see FIG. 15) in the third embodiment. The fourth embodiment is distinguishable in that a pair of flat surfaces 417a and 417b are formed at an opening portion 417 so as to range parallel along the Y direction. In other words, a projecting portion 442, formed so as to achieve the shape of a circular column as in the third embodiment, includes a pair of curved surfaces 442a and 442b defined as two separate curved surfaces by a center line CLx′ running through the center of the projecting portion 442 taken along the X direction. The pair of curved surfaces 442a and 442b respectively face opposite the pair of flat surfaces 417a and 417b. Butt-weld areas Ap41 are areas where the measurement G1 of the gap between the flat surface 417a and the curved surface 442a and the measurement G2 of the gap between the flat surface 417b and the curved surface 442b are equal to or less than the allowable weld measurement Gw.

FIG. 20 is a schematic plan view showing the second battery cell 401B offset relative to the first battery cell 401A along the widthwise direction (Y direction). The dimension of the opening portion 417 measured along the Y direction is greater than the dimension of the projecting portion 442 measured along the Y direction, and a space S4 is defined by the inner surfaces of the opening portion 417 and the outer surfaces of the projecting portion 442 (see FIG. 19). Thus, if the second battery cell 401B is disposed with an offset relative to the first battery cell 401A toward one side (upward in the figure) from the reference position along the widthwise direction (Y direction), a bus bar 410 is mounted with the projecting portion 442 set toward one end of the opening portion 417 along the Y direction, as indicated in FIG. 20.

Butt-weld areas Ap42 where the gap measurement G1 and the gap measurement G2 are equal to or less than the allowable weld measurement Gw can be secured even when the second battery cell 401B is offset from the reference position along the Y direction relative to the first battery cell 401A. Thus, butt-welding can be performed in the butt-weld areas Ap42 by ensuring that no weld defect occurs.

It is to be noted that although not shown, when the second battery cell 401B is disposed with an offset relative to the first battery cell 401A toward the other side (downward in the figure) from the reference position along the widthwise direction (Y direction), too, the relative displacement of a positive connection portion 416 and a positive terminal 404 is absorbed in the space S4, allowing the bus bar 410 to be disposed at a position at which it can be butt-welded to the positive terminal 404.

This variation of the fourth embodiment allows the bus bar 410 to be connected to the negative terminal 105 and the positive terminal 404 with the bus bar 410 positioned with ease even when the second battery cell 401B is disposed with an offset from the reference position along the Y direction relative to the first battery cell 401 A. Since this improves the ease of manufacturing, the manufacturing costs can be lowered.

It is to be noted that although not shown, the negative connection portion 111 in the bus bar 410 and the negative terminal 105 may be fastened together on the negative side with a screw instead of butt-welding the inner circumferential surface of the fitting hole 112 in the negative connection portion 111 to the outer circumferential surface of the axial portion 152 at the negative terminal 105.

### Fifth Embodiment

In reference to FIGS. 21 through 25, an assembled battery achieved in the fifth embodiment of the present invention will be described. It is to be noted that the following description will focus on features of the embodiment differentiating it from the first embodiment with the same reference signs assigned to elements in the figures that are identical to or equivalent to those in the first embodiment. FIG. 21 shows the electrode connecting device for the assembled battery achieved in the fifth embodiment in a perspective view. FIG. 22 is a schematic side elevation of a view taken from direction E in FIG. 21.

In the first embodiment explained earlier, the projecting portion 142 (terminal-side fitting portion) at the positive terminal 104 is fitted inside the opening portion 117 (bus bar-side fitting portion) in the bus bar 110A. The fifth embodiment is distinguishable in that the terminal-side fitting portion is configured with a pair of projecting portions 542A and 542B formed at a positive terminal 504, with a positive connection portion 516, used as a fitting portion at a bus bar 510, disposed between the pair of projecting portions 542A and 542B.

The assembled battery in the fifth embodiment is distinguishable from that achieved in the first embodiment in the structures adopted for the positive connection portion 516 and the positive terminal 504, but other structural elements thereof are similar to those in the first embodiment. As shown in FIG. 21, the positive terminal 504 includes a positive base portion 541 taking on a substantially rectangular parallelepiped shape and the pair of projecting portions 542A and 542B projecting upward from the upper surface of the positive base portion 541. The upper surface of the positive base portion 541 is a flat surface with which the bus bar 510 comes in contact. The pair of projecting portions 542A and 542B, running along the two sides of the positive terminal 504 facing opposite each other along the Y direction, range parallel along the X direction.

As FIG. 22 indicates, a thickness tp of the positive connection portion 516 is set substantially equal to a height hp of the projecting portions 542A and 542B at the positive terminal 504 (tp≈hp).

An end of the positive connection portion 516, located on its lower surface side, is chamfered so as to form a tapered area 516t. The upper ends of the pair of projecting portions 542A and 542B at the positive terminal 504 on the inner sides are chamfered so as to form tapered areas 542t. Through these measures, it is ensured that the positive connection portion 516 is inserted between the pair of projecting portions 542A and 542B at the positive terminal 504 with better ease. It is to be noted that the tapered areas may be formed through R chamfering instead of C chamfering.

FIG. 23 shows the electrode connecting device for the assembled battery achieved in the fifth embodiment in a schematic plan view. FIG. 23, which is similar to FIG. 7, shows a battery cell (a first battery cell 501 A) and another battery cell (a second battery cell 501B) adjacent to the first battery cell 501A, among battery cells constituting the assembled battery, disposed at the respective reference positions. It is to be noted that for purposes of clarity, the curvatures of a first curved outer surface 516a and a second curved outer surface 516b at the positive connection portion 516, to be described, are exaggerated in the figures.

A first flat inner surface 543a is formed at one projecting portion 542A in the pair of projecting portions 542A and 542B, with a second flat inner surface 543b formed at the other projecting portion 542B. The first flat inner surface 543a and the second flat inner surface 543b are each formed so as to range parallel to the X direction. A recessed fitting space is formed with the first flat inner surface 543a, the second flat inner surface 543b and the upper surface of the positive base portion 541. The two ends in the X direction of the fitting space are left open and the positive connection portion 516 is disposed in this fitting space.

The positive connection portion 516 includes the first curved outer surface 516a facing opposite the first flat inner surface 543a and the second curved outer surface 516b facing opposite the second flat inner surface 543b. The central area of the first curved outer surface 516a bows out further toward the first flat inner surface 543a compared to the two ends of the first curved outer surface 516a. The central area of the second curved outer surface 516b bows out further toward the second flat inner surface 543b compared to the two ends of the second curved outer surface 516b. The largest value taken for the distance between the first curved outer surface 516a and the second curved outer surface 516b at the positive connection portion 516 is slightly smaller than the distance between the first flat inner surface 543a and the second flat inner surface 543b.

The axial portion 152 of the negative terminal 105 is fitted in the fitting hole 112 at the negative connection portion 111 in the bus bar 510 and the positive connection portion 516 in the bus bar 510 is fitted in the space between the pair of projecting portions 542A and 542B so as to position the bus bar 510. As the positive connection portion 516 is fitted inside the space between the pair of projecting portions 542A and 542B, spaces S5 are formed between the first curved outer surface 516a and the first flat inner surface 543a and between the second curved outer surface 516b and the second flat inner surface 543b.

As will be explained later, any relative displacement of the positive connection portion 516 and the positive terminal 510 caused by misalignment of the second battery cell 501B relative to the first battery cell 501A, occurring when the bus bar 510 is being positioned, is absorbed in the spaces S5.

Once the bus bar 510 is positioned, the first curved outer surface 516a of the positive connection portion 516 and the first flat inner surface 543a of the projecting portion 542A are butt-welded together and the second curved outer surface 516b of the positive connection portion 516 and the second flat inner surface 543b of the projecting portion 542B are butt-welded together. Butt-weld areas Ap51 are areas where the measurement G1 of the gap between the first curved outer surface 516a and the first flat inner surface 543a and the measurement G2 of the gap between the second curved outer surface 516b and the second flat inner surface 543b are equal to or less than the allowable weld measurement Gw.

FIG. 24 is a schematic plan view showing the second battery cell 501B disposed with an offset relative to the first battery cell 501A along the laminating direction (X direction). As described earlier, the fitting space formed between the pair of projecting portions 542A and 542B has two open ends facing opposite each other along the X direction, and the spaces S5 are formed between the flat inner surface 543a at the projecting portion 542A and the curved outer surface 516a at the positive connection portion 516 and between the flat inner surface 543b at the projecting portion 542B and the curved outer surface 516b at the positive connection portion 516 (see FIG. 23). As a result, even if the second battery cell 501B is disposed with an offset from its reference position toward one side (to the right in the figure) along the laminating direction (X direction) relative to the first battery cell 501A, the relative displacement of the positive connection portion 516 and the positive terminal 504 is absorbed, and butt-weld areas Ap52 where the gap measurements G1 and G2 are equal to or less than the allowable weld measurement Gw can be secured. This, in turn, makes it possible to perform butt-welding in the butt-weld areas Ap52 while ensuring that no weld defect occurs.

It is to be noted that although not shown, when the second battery cell 501B is disposed with an offset relative to the first battery cell 501A toward the other side (to the left in the figure) from the reference position along the laminating direction (X direction), too, the relative displacement of the positive connection portion 516 and the positive terminal 504 is absorbed in the spaces S5, allowing the bus bar 510 to be disposed at a position at which it can be butt-welded to the positive terminal 504.

FIG. 25 is a schematic plan view of the second battery cell 501B disposed with an offset along the widthwise direction (Y direction) relative to the first battery cell 501A. If the second battery cell 501B is disposed with an offset from the reference position along the widthwise direction (Y direction) relative to the first battery cell 501 A, the bus bar 510 is rotated relative to the reference position by a specific angle around the axial portion 152 of the negative terminal 105 forming the rotational center, as indicated in FIG. 25.

As described earlier, the fitting space formed between the pair of projecting portions 542A and 542B has two open ends facing opposite each other along the X direction, and the spaces S5 are formed between the flat inner surface 543a at the projecting portion 542A and the curved outer surface 516a at the positive connection portion 516 and between the flat inner surface 543b at the projecting portion 542B and the curved outer surface 516b at the positive connection portion 516 (see FIG. 23). Thus, even if the second battery cell 501B is disposed with an offset from its reference position toward one side (upward in the figure) along the widthwise direction (Y direction) relative to the first battery cell 501 A, the relative displacement of the positive connection portion 516 and the positive terminal 504 is absorbed through these measures, and butt-weld areas Ap53 where the gap measurements G1 and G2 are equal to or less than the allowable weld measurement Gw can be secured. As a result, butt-welding can be performed in the butt-weld areas Ap53 by ensuring that no weld defect occurs.

It is to be noted that although not shown, when the second battery cell 501B is disposed with an offset relative to the first battery cell 501A toward the other side (downward in the figure) from the reference position along the widthwise direction (Y direction), too, the relative displacement of the positive connection portion 516 and the positive terminal 504 is absorbed in the spaces S5, allowing the bus bar 510 to be disposed at a position at which it can be butt-welded to the positive terminal 504.

Furthermore, although not shown, even when the second battery cell 501B is disposed with an offset relative to the first battery cell 501A by a specific distance from the reference position along the X direction and also by a specific distance from the reference position along the Y direction, too, the bus bar 510 can be positioned so as to achieve a butt-welding enabled state by fitting the fitting hole 112 in the bus bar 510 around the axial portion 152 of the negative terminal 105 and fitting the positive connection portion 516 in the bus bar 510 between the pair of projecting portions 542A and 542B of the positive terminal 504.

The fifth embodiment described above allows the bus bar 510 to be connected to the negative terminal 105 and the positive terminal 504 with the bus bar 510 positioned with ease even when the battery cells 501 are misaligned, as does the first embodiment. Since this improves the ease of manufacturing, the manufacturing costs can be lowered.

It is to be noted that although not shown, the negative connection portion 111 in the bus bar 510 and the negative terminal 105 may be fastened together on the negative side with a screw instead of by butt-welding the inner circumferential surface of the fitting hole 112 in the negative connection portion 111 to the outer circumferential surface of the axial portion 152 at the negative terminal 105.

### Sixth Embodiment

In reference to FIGS. 26 through 29, an assembled battery achieved in the sixth embodiment will be described. It is to be noted that the following description will focus on features of the embodiment differentiating it from the fifth embodiment with the same reference signs assigned to elements in the figures that are identical to or equivalent to those in the fifth embodiment. FIG. 26 shows the electrode connecting device for the assembled battery achieved in the sixth embodiment in a perspective view and FIG. 27 is a schematic plan view of the electrode connecting device. FIG. 27, which is similar to FIG. 23, shows a battery cell (a first battery cell 601 A) and another battery cell (a second battery cell 601B) adjacent to the first battery cell 601A, among battery cells constituting the assembled battery, disposed at the respective reference positions. It is to be noted that for purposes of clarity, the curvatures of a first curved inner surface 643a at a projecting portion 642A and a second curved inner surface 643b at a projecting portion 642B, which will be explained later, are exaggerated in the figures.

In the fifth embodiment, the pair of flat surfaces 543a and 543b, ranging parallel along the X direction, are formed at the pair of projecting portions 542A and 542B and the pair of curved surfaces 516a and 516b respectively facing opposite the pair of flat surfaces. 543a and 543b are formed at the positive connection portion 516.

The sixth embodiment is distinguishable from this in that a pair of flat surfaces 616a and 616b, ranging parallel along the X direction, are formed at a positive connection portion 616 used as a fitting portion at a bus bar 610 and curved surfaces 643a and 643b respectively facing opposite the pair of flat surfaces 616a and 616b are formed at a pair of projecting portions 642A and 642B constituting a terminal-side fitting portion at a positive terminal 604, as illustrated in FIG. 27.

The positive connection portion 616 is a substantially rectangular flat plate, with the first flat outer surface 616a and the second flat outer surface 616b thereof formed to range parallel to the X direction at the reference position.

The first curved inner surface 643a facing opposite the first flat outer surface 616a is formed at one projecting portion 642A in the pair of projecting portions 642A and 642B, with the second curved inner surface 643b facing opposite the second flat outer surface 616b formed at the other projecting portion 642B.

The central area of the first curved inner surface 643a bows out further toward the first flat outer surface 616a compared to the two ends of the first curved inner surface 643a. The central area of the second curved inner surface 643b bows out further toward the second flat outer surface 616b compared to the two ends of the second curved inner surface 643b. The smallest value taken for the distance between the first curved inner surface 643a at the projecting portion 642A and the second curved inner surface 643b at the projecting portion 642B is slightly greater than the measurement of the positive connection portion 616 taken along the Y direction.

As shown in FIG. 26, a recessed fitting space is formed with the first curved inner surface 643a, the second curved inner surface 643b and the upper surface of a positive base portion 641. The two ends of the fitting space, facing opposite each other along the X direction, are left open, and the positive connection portion 616 is disposed in this fitting space.

The axial portion 152 of the negative terminal 105 is fitted in the fitting hole 112 at the negative connection portion 111 in the bus bar 610 and the positive connection portion 616 in the bus bar 610 is fitted in the space between the pair of projecting portions 642A and 642B so as to position the bus bar 610. As the positive connection portion 616 is fitted inside the space between the pair of projecting portions 642A and 642B, spaces S6 are formed between the first curved inner surface 643a and the first flat outer surface 616a and between the second curved inner surface 643b and the second flat outer surface 616b, as shown in FIG. 27.

As will be explained later, any relative displacement of the positive connection portion 616 and the positive terminal 610 caused by misalignment of the second battery cell 601B relative to the first battery cell 601A occurring when the bus bar 610 is being positioned, is absorbed in the spaces S6.

Once the bus bar 610 is positioned, the first flat outer surface 616a of the positive connection portion 616 and the first curved inner surface 643a of the projecting portion 642A are butt-welded together and the second flat outer surface 616b of the positive connection portion 616 and the second curved inner surface 643b of the projecting portion 642A are butt-welded together. Butt-weld areas Ap61 are areas where the measurement G1 of the gap between the first flat outer surface 616a and the first curved inner surface 643a and the measurement G2 of the gap between the second flat outer surface 616b and the second curved inner surface 643b are equal to or less than the allowable weld measurement Gw.

FIG. 28 is a schematic plan view showing the second battery cell 601B disposed with an offset relative to the first battery cell 601A along the laminating direction (X direction). As described earlier, the fitting space formed between the pair of projecting portions 642A and 642B has two open ends in the X direction, and the spaces S6 are formed between the curved inner surface 643a at the projecting portion 642A, and the flat outer surface 616a at the positive connection portion 616 and between the curved inner surface 643b at the projecting portion 642B and the flat outer surface 616b at the positive connection portion 616 (see FIG. 27). Thus, even if the second battery cell 601B is disposed with an offset from the reference position toward one side (to the right in the figure) along the laminating direction (X direction) relative to the first battery cell 601A, the relative displacement of the positive connection portion 616 and the positive terminal 604 is absorbed through these measures, and butt-weld areas Ap62 where the gap measurements G1 and G2 are equal to or less than the allowable weld measurement Gw can be secured. As a result, butt-welding can be performed in the butt-weld areas Ap62 by ensuring that no weld defect occurs.

It is to be noted that although not shown, when the second battery cell 601B is disposed with an offset relative to the first battery cell 601 A toward the other side (to the left in the figure) from the reference position along the laminating direction (X direction), too, the relative displacement of the positive connection portion 616 and the positive terminal 604 is absorbed in the spaces S6, allowing the bus bar 610 to be disposed at a position at which it can be butt-welded to the positive terminal 604.

FIG. 29 is a schematic plan view of the second battery cell 601B disposed with an offset along the widthwise direction (Y direction) relative to the first battery cell 601A. If the second battery cell 601B is disposed with an offset relative to the first battery cell 601A along the widthwise direction (Y direction) relative to the first battery cell 601A, the bus bar 610 is rotated relative to the reference position by a specific angle around the axial portion 152 of the negative terminal 105 forming the rotational center, as indicated in FIG. 29.

As described earlier, the fitting space formed between the pair of projecting portions 642A and 642B has two open ends facing opposite each other along the X direction, and the spaces S6 are formed between the curved inner surface 643a at the projecting portion 642A and the flat outer surface 616a at the positive connection portion 616 and between the curved inner surface 643b at the projecting portion 542B and the flat outer surface 616b at the positive connection portion 616 (see FIG. 27). Thus, even if the second battery cell 601B is disposed with an offset from the reference position toward one side (upward in the figure) along the widthwise direction (Y direction) relative to the first battery cell 601A, the relative displacement of the positive connection portion 616 and the positive terminal 604 is absorbed through these measures, and butt-weld areas Ap63 where the gap measurements G1 and G2 are equal to or less than the allowable weld measurement Gw can be secured. As a result, butt-welding can be performed in the butt-weld areas Ap63 by ensuring that no weld defect occurs.

It is to be noted that although not shown, when the second battery cell 601B is disposed with an offset relative to the first battery cell 601A toward the other side (downward in the figure) from the reference position along the widthwise direction (Y direction), too, the relative displacement of the positive connection portion 616 and the positive terminal 604 is absorbed in the spaces S6, allowing the bus bar 610 to be disposed at a position at which it can be butt-welded to the positive terminal 604.

Furthermore, although not shown, even when the second battery cell 601E is disposed with an offset relative to the first battery cell 601A by a specific distance from the reference position along the X direction and also by a specific distance from the reference position along the Y direction, too, the bus bar 610 can be positioned so as to achieve a butt-welding enabled state by fitting the fitting hole 112 in the bus bar 610 around the axial portion 152 of the negative terminal 105 and fitting the positive connection portion 616 in the bus bar 610 between the pair of projecting portions 642A and 642B of the positive terminal 604.

The sixth embodiment described above allows the bus bar 610 to be connected to the negative terminal 105 and the positive terminal 604 with the bus bar 610 positioned with ease even when the battery cells 601 are misaligned, as does the fifth embodiment. Since this improves the ease of manufacturing, the manufacturing costs can be lowered.

It is to be noted that although not shown, the negative connection portion 111 in the bus bar 610 and the negative terminal 105 may be fastened together on the negative side with a screw instead of by butt-welding the inner circumferential surface of the fitting hole 112 in the negative connection portion 111 to the outer circumferential surface of the axial portion 152 at the negative terminal 105.

The following variations are also within the scope of the present invention and one of the variations or a plurality of variations may be adopted in combination with any of the embodiments described above.

(1) While the bus bar 510 and the positive terminal 504 are butt-welded together and the bus bar 610 and the positive terminal 604 are butt-welded together in the fifth embodiment and the sixth embodiment described above, the present invention is not limited to these examples. That bus bar 510 or 610 and the positive terminal 504 or 604 may instead be lap-welded over a lap-weld area Aw indicated as a shaded area in FIG. 30 and FIG. 31.
(2) In the embodiments described above, the axial portion 152 is formed at the negative terminal 105, the bus bar is allowed to rotate freely around a rotational center at the axial portion 152 and space for misalignment tolerance is formed on the positive side. However, the present invention is not limited to these details. For instance, the structural features on the positive side and the structural features on the negative side may be switched. Namely, a structure that allows the bus bar to be rotated freely may be achieved on the positive side with space for misalignment tolerance formed on the negative side.
(3) In the fourth embodiment, the bus bar 410 is allowed to rotate freely around rotational center at the axial portion 152 of the negative terminal 105, and the bus bar 410 is welded after it is positioned in correspondence to any misalignment of the battery cells. However, the present invention is not limited to this example and the bus bar 410 does not need to rotate freely around the axial portion 152 at the negative terminal 105. In such a case, the bus bar 410 can be positioned with ease when the battery cells 401 are disposed with an offset along the Y direction.
(4) While an explanation has been given on an example in which prismatic battery cells configuring the assembled battery are lithium-ion secondary battery cells, the present invention is not limited to this example and may be adopted in conjunction with any of various types of prismatic secondary battery cells, including nickel-metal hydride batteries, achieved by housing a charge/discharge element in a container.

It is to be noted that the embodiments and variation thereof described above simply represent examples and the present invention is in no way limited to these examples as long as the features characterizing the present invention remain intact. Any other mode conceivable within the technical range of the present invention should, therefore, be considered to be within the scope of the present invention.

1. An assembled battery comprising:
a plurality of battery cells arranged in a laminated structure and connected via a bus bar, wherein:
the battery cells each include a first electrode terminal and a second electrode terminal;
the bus bar includes a first electrode connection portion connected to the first electrode terminal of one battery cell and a second electrode connection portion connected to the second electrode terminal of another battery cell adjacent to the one battery cell;
a connecting device is configured with the bus bar, the first electrode terminal of the one battery cell and the second electrode terminal of the other battery cell, wherein the connection device includes a space-forming portion that forms a space where relative displacement of the second electrode connection portion and the second electrode terminal, occurring when the other battery cell is disposed with an offset from a reference position thereof along a laminating direction in which the battery cells are laminated and/or a direction running perpendicular to the laminating direction relative to the one battery cell, is absorbed; and
the second electrode terminal and the second electrode connection portion are butt-welded or lap-welded.

2. The assembled battery according to claim 1, wherein:
the first electrode terminal includes a first base portion with which the first electrode connection portion comes in contact and an axial portion projecting from the first base portion;
a fitting hole to be fitted around the axial portion of the first electrode terminal is formed in the first electrode connection portion;
the second electrode terminal includes a second base portion with which the second electrode connection portion comes in contact and a terminal-side fitting portion located at the second base portion;
the second electrode connection portion includes a bus bar-side fitting portion fitted together with the terminal-side fitting portion; and
the space forming portion is constituted with the terminal-side fitting portion and the bus bar-side fitting portion.

3. The assembled battery according to claim 2, wherein:
the first electrode connection portion and the first electrode terminal are welded together or fastened together via a fastening member after the axial portion at the first electrode terminal is rotatably fitted in the fitting hole in the first electrode connection portion.

4. The assembled battery according to claim 3, wherein:
the terminal-side fitting portion includes a pair of flat surfaces formed to be parallel to the laminating direction;
the bus bar-side fitting portion includes a pair of curved surfaces each facing opposite one of the pair of flat surfaces; and
a central area of each of the curved surfaces bows out further toward one of the flat surfaces facing opposite the curved surface compared to two ends of the curved surface.

5. The assembled battery according to claim 4, wherein:
the bus bar-side fitting portion is an opening portion having the pair of curved surfaces; and
the terminal-side fitting portion is a projecting portion having the pair of flat surfaces.

6. The assembled battery according to claim 4, wherein:
the terminal-side fitting portion is constituted with a pair of projecting portions;
the pair of projecting portions each include one of the flat surfaces; and
the bus bar-side fitting portion is disposed between the pair of projecting portions.

7. The assembled battery according to claim 3, wherein:
a pair of flat surfaces parallel to each other are formed at the bus bar-side fitting portion;
a pair of curved surfaces each facing opposite one of the pair of flat surfaces are formed at the terminal-side fitting portion; and
a central area of each of the curved surfaces bows out further toward one of the flat surfaces facing opposite the curved surface compared to two ends of the curved surface.

8. The assembled battery according to claim 7, wherein:
the bus bar-side fitting portion is an opening portion having the pair of flat surfaces formed to be parallel to the laminating direction; and
the terminal-side fitting portion is a projecting portion having the pair of curved surfaces.

9. The assembled battery according to claim 7, wherein:
the terminal-side fitting portion is constituted with a pair of projecting portions;
the pair of projecting portions each include one of the curved surfaces; and
the bus bar-side fitting portion is disposed between the pair of projecting portions so as to allow the pair of flat surfaces to range parallel to the laminating direction.

10. The assembled battery according to claim 2, wherein:
a front end area of the axial portion, an end area of the fitting hole located toward the first base portion, a front end area of the terminal-side fitting portion and an end area of the bus bar-side fitting portion located toward the second base portion are each chamfered.

11. The assembled battery according to claim 2, wherein:
the axial portion takes on a circular column shape;
the fitting hole in the first electrode connection portion is a circular hole;
a connector terminal, to which a voltage detection line for battery cell voltage detection is connected, is disposed at the first electrode connection portion; and
an outer circumferential surface of the axial portion and an inner circumferential surface of the fitting hole are butt-welded over an entire circumference of the axial portion.
